(19) United States
(12) Patent Application Publication
(10) Pub. No.: US 2023/0357934 A1
(43) Pub. Date: Nov. 9, 2023

(54) MODULAR ELECTROLYSIS SYSTEM AND METHOD FOR FUEL GENERATION IN A SOLID-OXIDE ELECTROLYSIS CELL

(71) Applicant: SeeO2 Energy Inc., Calgary (CA)

(72) Inventors: Beatriz Molero Sanchez, Calgary (CA); Aniket Pratap, Surat (IN); Paul Addo, Calgary (CA); Khaled Al-Hamed, Calgary (CA)

(21) Appl. No.: 18/195,900

(22) Filed: May 10, 2023

Related U.S. Application Data
(63) Continuation-in-part of application No. 17/828,996, filed on May 31, 2022.
(60) Provisional application No. 63/340,384, filed on May 10, 2022.
(60) Provisional application No. 63/340,389, filed on May 10, 2022.
(60) Provisional application No. 63/341,626, filed on May 13, 2022.
(60) Provisional application No. 63/194,720, filed on May 28, 2021.

(51) Int. Cl. C25B 1/23; H01M 8/18; C25B 15/021; C25B 15/08; C25B 15/027; C25B 9/60; C25B 9/67; C25B 13/07

(52) U.S. Cl. CPC C25B 1/23; H01M 8/186; C25B 15/021; C25B 15/085; C25B 15/027; C25B 9/60; C25B 9/67; C25B 13/07; H01M 2008/1293

(57) ABSTRACT

One variation of an electrolyzer system includes a skid loaded with a set of modules including a feed-supply module, configured to generate a feed mixture of carbon dioxide and water, and, an electrolysis module including: a cell stack arranged within an insulated housing and configured to receive metered volumes of the feed mixture from the feed-supply module to generate a fuel mixture of syngas, water, and carbon dioxide via electrolysis; and a set of heating elements configured to regulate temperature of the cell stack within a target temperature range and regulate temperatures of the feed mixture, the air mixture, and the fuel mixture within the insulated housing. The skid can further include: a processing module configured to extract syngas from the fuel mixture received from the electrolysis module; and a power module configured to drive a voltage across the cell stack to promote electrolysis of the feed mixture.

### CROSS-REFERENCE TO RELATED APPLICATIONS

This application claims the benefit of U.S. Provisional Application No. 63/340,384, filed on 10 May 2022, U.S. Provisional Application No. 63/340,389 filed on 10 May 2022, and U.S. Provisional Application No. 63/341,626, filed on 13 May 2022, each of which is incorporated in its entirety by this reference.

This application is also a Continuation-In-Part Application of U.S. patent application Ser. No. 17/828,996, filed on 31 May 2022, which claims the benefit of U.S. Provisional Application No. 63/194,720, filed on 28 May 2021, each of which is incorporated in its entirety by this reference.

### TECHNICAL FIELD

This invention relates generally to the field of electrolyzer cells and more specifically to a new and useful system and method for fuel generation in a solid-oxide electrolysis cell in the field of electrolyzer cells.

### BRIEF DESCRIPTION OF THE FIGURES

FIG. 1 is a schematic representation of a method;

FIG. 2 is a schematic representation of one variation of the method;

FIG. 3 is a schematic representation of one variation of the method;

FIG. 4 is a schematic representation of one variation of the method;

FIGS. 5A and 5B are schematic representations of a system;

FIG. 6 is a schematic representation of one variation of the system;

FIG. 7 is a schematic representation of one variation of the method;

FIG. 8 is a schematic representation of a reversible fuel cell stack;

FIG. 9 is a schematic representation of a reversible fuel cell stack; and

FIG. 10 is a schematic representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

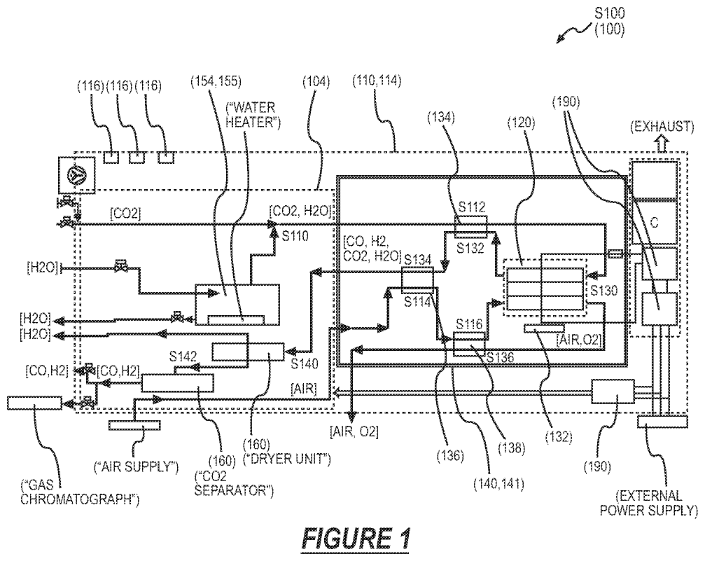

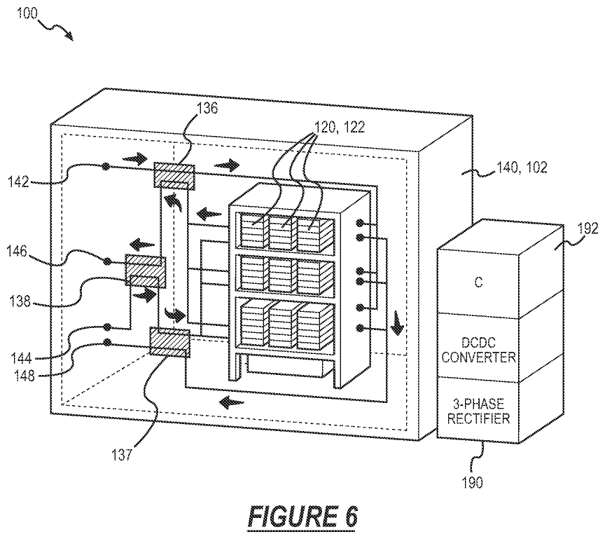

As shown in FIGS. 1-3, 6, and 9, a method for S100 includes: during a humidification cycle, at a humidification unit 151, humidifying a gaseous mixture including carbon dioxide with a volume of water to generate a feed mixture including carbon dioxide and water in Block Silo; during a heating cycle, conveying the feed mixture, from the humidification unit 151, across a first side of a first heat exchanger 136 to heat the feed mixture from a first feed temperature at a first heat exchanger inlet to a second feed temperature, within a target feed temperature range, at a first heat exchanger outlet, the second feed temperature exceeding the first feed temperature in Block S112; during an electrolysis cycle, conveying an air mixture including oxygen through an anode layer 126 of a reversible fuel cell 122, in a set of reversible fuel cells 122, in a cell stack 120 and conveying the feed mixture from the first heat exchanger outlet across a cathode layer 124 of the reversible fuel cell 122 to generate a first fuel mixture at the cathode layer 124 via electrolysis of the feed mixture, the first fuel mixture including syngas and a first concentration of secondary materials including water and carbon dioxide in Block S130; and, during a cooling cycle, conveying the first fuel mixture from the cell stack 120 over a second side of the first heat exchanger 136 to cool the first fuel mixture from a first fuel temperature at a second heat exchanger inlet to a second fuel temperature at a second heat exchanger outlet, the second fuel temperature falling below the first fuel temperature in Block S132. The method S100 further includes, during a purification cycle: conveying the first fuel mixture from the second heat exchanger outlet through a dryer unit 162 configured to reduce a dew point of syngas in the first fuel mixture and promote separation of water from the fuel mixture, to generate a second fuel mixture including syngas and a second concentration of secondary materials including carbon dioxide, the second concentration less than the first concentration in Block S140; and conveying the second fuel mixture through a separator unit 164 configured to extract carbon dioxide from the second fuel mixture to generate a third fuel mixture including a concentration of syngas exceeding a threshold concentration and collecting the third fuel mixture at a separator outlet of the separator unit 164 in Block S142.

One variation of the method S100 includes, during a heating period: conveying a feed mixture, including water, across a first side of a first heat exchanger 134 to heat the feed mixture from a first feed temperature at a first heat exchanger inlet to a second feed temperature, within a target feed temperature range, at a first heat exchanger outlet, the second feed temperature exceeding the first feed temperature in Block S112; and conveying an air mixture including a first concentration of oxygen across a second side of a second heat exchanger 134 to heat the air mixture from a first air temperature at a second heat exchanger inlet to a second air temperature, within a target air temperature range, at a second heat exchanger outlet, the second air temperature exceeding the first air temperature in Block S124. The method S100 further includes, during an electrolysis period: conveying the air mixture from the second heat exchanger outlet across an anode layer 126 of a reversible fuel cell 122, in a cell stack 120, to generate an oxygen mixture via oxidation of the air mixture, the oxygen mixture including a second concentration of oxygen exceeding the first concentration, and conveying the feed mixture from the first heat exchanger outlet across a cathode layer 124 of the reversible fuel cell 122 to generate a first fuel mixture at the cathode layer 124 via electrolysis of the feed mixture, the first fuel mixture including hydrogen and a third concentration of secondary materials including water in Block S130. The method S100 further includes, during a cooling period: conveying the first fuel mixture across a third side of the first heat exchanger 134 to cool the first fuel mixture from a first fuel temperature at a third heat exchanger inlet to a second fuel temperature at a third heat exchanger outlet, the second fuel temperature falling below the first fuel temperature in Block S132; and conveying the oxygen mixture across a fourth side of the second heat exchanger 134 to cool the oxygen mixture from a first oxygen temperature at a fourth heat exchanger inlet to a second oxygen temperature at a fourth heat exchanger outlet, the second oxygen temperature falling below the first oxygen temperature in Block S136. The method S100 further includes: conveying the first fuel mixture from the second heat exchanger outlet through a dryer unit 162 configured to reduce a dew point of hydrogen in the first fuel mixture and promote separation of water from the first fuel mixture, to generate a second fuel mixture including hydrogen and a fourth concentration of secondary materials less than the third concentration in Block S140; and collecting the second fuel mixture at a dryer outlet of the dryer unit 162 in Block S142.

One variation of the method S100 includes, during a heating period: conveying a feed mixture, including carbon dioxide, across a first side of a first heat exchanger 134 to heat the feed mixture from a first feed temperature at a first heat exchanger inlet to a second feed temperature, within a target feed temperature range, at a first heat exchanger outlet, the second feed temperature exceeding the first feed temperature in Block S112; and conveying an air mixture including a first concentration of oxygen across a second side of a second heat exchanger 134 to heat the air mixture from a first air temperature at a second heat exchanger inlet to a second air temperature, within a target air temperature range, at a second heat exchanger outlet, the second air temperature exceeding the first air temperature in Block S124. The method S100 further includes, during an electrolysis period: conveying the air mixture from the second heat exchanger outlet across an anode layer 126 of a reversible fuel cell 122, in a cell stack 120, to generate an oxygen mixture via oxidation of the air mixture, the oxygen mixture including a second concentration of oxygen exceeding the first concentration, and conveying the feed mixture from the first heat exchanger outlet across a cathode layer 124 of the reversible fuel cell 122 to generate a first fuel mixture at the cathode layer 124 via electrolysis of the feed mixture, the first fuel mixture including carbon monoxide and a third concentration of secondary materials including carbon dioxide in Block S130. The method S100 further includes, during a cooling period: conveying the first fuel mixture across a third side of the first heat exchanger 134 to cool the first fuel mixture from a first fuel temperature at a third heat exchanger inlet to a second fuel temperature at a third heat exchanger outlet, the second fuel temperature falling below the first fuel temperature in Block S132; and conveying the oxygen mixture across a fourth side of the second heat exchanger 134 to cool the oxygen mixture from a first oxygen temperature at a fourth heat exchanger inlet to a second oxygen temperature at a fourth heat exchanger outlet, the second oxygen temperature falling below the first oxygen temperature in Block S136. The method S100 further includes: conveying the first fuel mixture from the second heat exchanger outlet through a separation unit 164 configured to promote separation of carbon dioxide from carbon monoxide in the fuel mixture, to generate a second fuel mixture including carbon monoxide and a fourth concentration of secondary materials less than the third concentration in Block S140; and collecting the second fuel mixture at an outlet of the separation unit 164 in Block S142.

One variation of the method S100 includes, during a live period for an electrolysis module 102 installed on a skid 110: selectively distributing power from a power supply to a cell stack 120 to regulate a current applied across the cell stack 120 within a target current range in Block S160, the cell stack 120 transiently installed within a housing of the electrolysis module 102 and including a set of reversible fuel cells 122 arranged in a vertical stack and a set of interconnects 128 interposed between the set of reversible fuel cells 122, each reversible fuel cell 122, in the set of reversible fuel cells 122, including: an anode layer 126, in a set of anode layers 126, configured to oxidize fluid flowing over the anode layer 126; a cathode layer 124, in a set of cathode layers 124, configured to reduce fluid flowing over the cathode layer 124; an electrolyte layer 123, in a set of electrolyte layers 123, interposed between the anode layer 126 and the cathode layer 124 and configured to promote transfer of electrons from fluid flowing over the anode layer 126 into fluid flowing over the cathode layer 124; and selectively distributing power from the power supply to a set of heating elements 130 installed within the housing to regulate a stack temperature of the cell stack 120 within a target stack temperature range corresponding to the target stack efficiency. The method S100 further includes, during a first electrolysis cycle within the live period: conveying an air mixture from an air supply across the set of anode layers 126 at a first air flow rate corresponding to a first current applied to the reversible fuel cell 122 during the first electrolysis cycle in Block S130; and conveying a feed mixture, including water, from a feed supply across the set of cathode layers 124 at a first feed flow rate to generate a fuel mixture including hydrogen via electrolysis, the first feed flow rate corresponding to the first current in Block S130. The method S100 further includes, during a second electrolysis cycle within the live period: conveying the air mixture from the air supply across the set of anode layers 126 at a second air flow rate corresponding to a second current applied to the reversible fuel cell 122 during the first electrolysis cycle in Block S130; and conveying the feed mixture from the feed supply across the set of cathode layers 124 at a second feed flow rate to generate the fuel mixture via electrolysis, the second feed flow rate corresponding to the second current in Block S130.

### 2. System

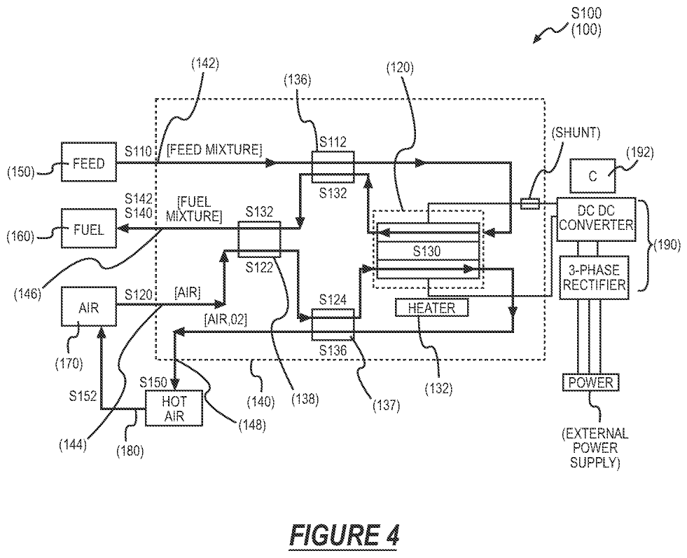

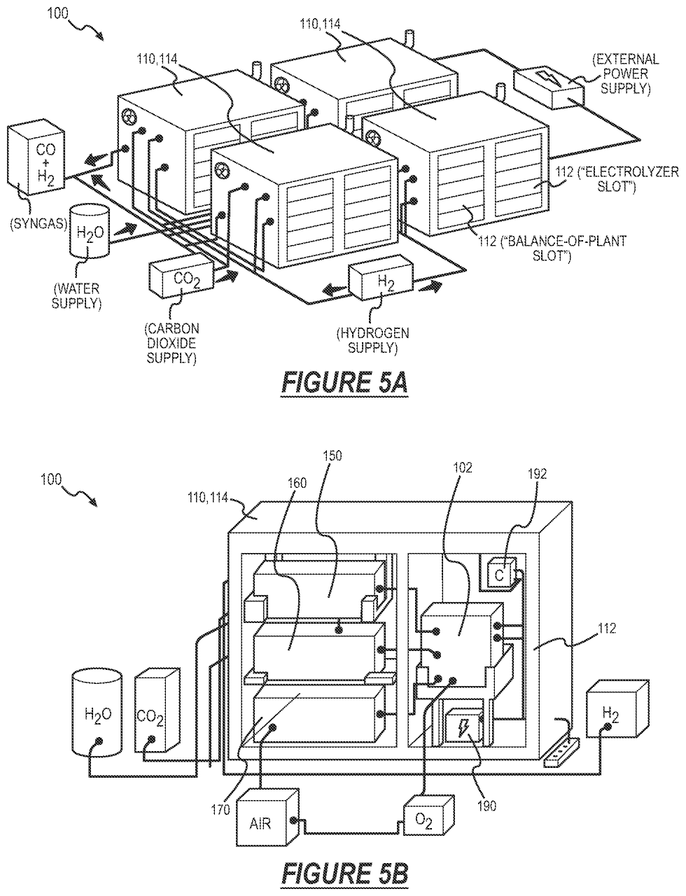

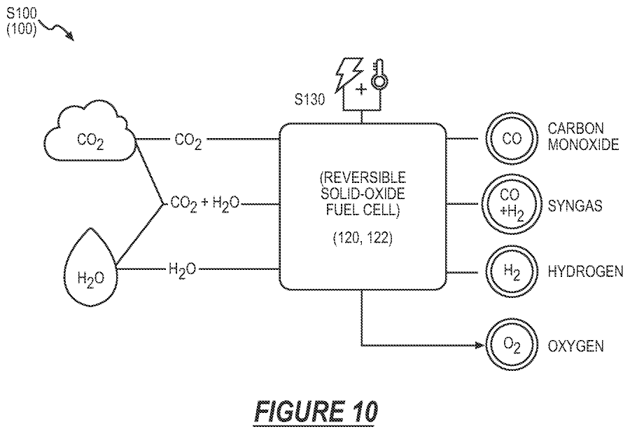

As shown in FIGS. 1-10, a system 100 includes: a skid 110 defining a target footprint; and a set of modules—installed on the skid 110—including a feed-supply module 150, an electrolysis module 102, a fuel-processing module 160, and a power module 190.

The feed-supply module 150 can include a humidification unit 151 configured to humidify carbon dioxide—received from a carbon dioxide supply—flowing through the humidification unit 151 to generate a feed mixture including carbon dioxide and water.

The electrolysis module 102 can include a housing defining: a feed inlet 142 configured to ingest the feed mixture; a fuel outlet 146 fluidly coupled to the feed inlet 142; an air inlet 144 configured to ingest an air mixture including oxygen; and an air outlet 148 fluidly coupled to the air inlet 144. The electrolysis module 102 can further include a cell stack 120: including a first reversible fuel cell 122, in a set of reversible fuel cells 122, including an electrolyte layer 123, a cathode layer 124 arranged across the electrolyte layer 123, and an anode layer 126 arranged across the electrolyte layer 123 opposite the cathode layer 124; defining a set of channels including a cathode channel, fluidly coupled to the feed inlet 142 and the fuel outlet 146 and configured to communicate the feed mixture from the feed inlet 142 across the cathode layer 124, and an anode channel fluidly coupled to the air inlet 144 and the air outlet 148 and configured to communicate the air mixture from the air inlet 144 across the anode layer 126; and configured to generate a fuel mixture via electrolysis of the feed mixture at the cathode layer 124, the fuel mixture including a first concentration of syngas and a set of secondary materials including water and carbon dioxide. The electrolysis module 102 can further include a set of heating elements 130 including a first heating element 132 coupled to the cell stack 120 and configured to regulate temperature of the cell stack 120 within a target stack temperature range.

The fuel-processing module 160 includes: a first separation unit 162 (e.g., a water separation unit) configured to receive the fuel mixture from the fuel outlet 146 and promote separation of water from the fuel mixture to generate a second fuel mixture including a second concentration of syngas exceeding the first concentration; and a second separation unit 164 (e.g., a carbon dioxide separation unit) configured to receive the second fuel mixture from the first separation unit and promote separation of carbon dioxide from the second fuel mixture to generate a third fuel mixture including a third concentration of syngas exceeding the second concentration.

The power module 190 is configured to: drive a voltage between the cathode layer 124 and the anode layer 126; and supply power to the feed-supply module 150, the electrolysis module 102, and the fuel-processing module 160.

In one variation, the system 100 further includes: set of sensors 116 installed on the skid 110 and configured to output a set of signals representing a set of operating conditions within the electrolysis module 102, the feed-supply module 150, and the processing module 160; and a controller configured to read the set of signals from the set of sensors 116, interpret a set of operating conditions within the electrolysis module 102, the feed supply module 150, and the processing module 160 based on the set of signals, and, selectively distribute power to the electrolysis module 102, the feed supply module 150, and the processing module 160 based on the set of operating conditions.

One variation of the system 100 includes: a skid 110; and an electrolysis module 102 configured to transiently install on the skid 110. The electrolysis module 102 can include a housing 140 defining: a feed inlet 142 configured to couple to a feed supply to receive metered volumes of a feed mixture including water; an air inlet 144 configured to couple to an air supply to receive metered volumes of an air mixture including oxygen at the air inlet 144; a fuel outlet 146 fluidly coupled to the feed inlet 142; and an air outlet 148 fluidly coupled to the air inlet 144. The electrolysis module 102 can further include a cell stack 120: configured to transiently install within the housing; including a first reversible fuel cell 122 including an electrolyte layer 123, a cathode layer 124 arranged across the electrolyte layer 123, and an anode layer 126 arranged across the electrolyte layer 123 opposite the cathode layer 124; and configured to communicate the feed mixture across the cathode layer 124 and the air mixture across the anode layer 126 to generate a fuel mixture at the cathode layer 124 via electrolysis, the fuel mixture including a first concentration of hydrogen and a set of secondary materials. The electrolysis module 102 can further include a set of heating elements 130 installed within the housing and including: a stack heater 132 configured to regulate temperature of the cell stack 120 within a target stack temperature range configured to promote electrolysis; a first heat exchanger 136—defining a first side fluidly coupled to the feed inlet 142 and the cathode layer 124 and a second side fluidly coupled to the cathode layer 124 and the fuel outlet 146—configured to communicate thermal energy from the fuel mixture flowing over the first side of the heat exchanger 136 into the feed mixture flowing over the second side of the heat exchanger 136 to cool the fuel mixture and heat the feed mixture to a feed temperature within a target feed temperature range defined for the cell stack 120; and a second heat exchanger 137—defining a third side fluidly coupled to the air inlet 144 and the anode layer 126 and a fourth side fluidly coupled to the anode layer 126 and the air outlet—configured to communicate thermal energy from the oxygen mixture flowing over the third side of the second heat exchanger 137 into the air mixture flowing over the fourth side of the second heat exchanger 137 to cool the oxygen mixture and heat the air mixture to an air temperature within a target air temperature range defined for the cell stack 120. In this variation, the system 100 can further include: a power module 190 configured to drive a voltage between the cathode layer 124 and the anode layer 126 to promote electrolysis of water flowing over the cathode layer 124; and a controller 192 configured to selectively distribute power from the power module 190 to the set of heating elements 130 to regulate temperatures of fluid within the cell stack 120.

In one variation, the system 100 can further include a fuel processing module 160 including a dryer unit 162 configured to: receive the fuel mixture from the fuel outlet 146 and promote separation of water from the fuel mixture to generate a second fuel mixture including a second concentration of hydrogen exceeding the first concentration.

One variation of the system 100 includes: a skid 110; and an electrolysis module 102 configured to transiently install on the skid 110. The electrolysis module 102 can include a housing 140 defining: a feed inlet 142 configured to couple to a feed supply to receive metered volumes of a feed mixture including carbon dioxide; an air inlet 144 configured to couple to an air supply to receive metered volumes of an air mixture including oxygen at the air inlet 144; a fuel outlet 146 fluidly coupled to the feed inlet 142; and an air outlet 148 fluidly coupled to the air inlet 144. The electrolysis module 102 can further include a cell stack 120: configured to transiently install within the housing; including a first reversible fuel cell 122 including an electrolyte layer 123, a cathode layer 124 arranged across the electrolyte layer 123, and an anode layer 126 arranged across the electrolyte layer 123 opposite the cathode layer 124; and configured to communicate the feed mixture across the cathode layer 124 and the air mixture across the anode layer 126 to generate a fuel mixture at the cathode layer 124 via electrolysis, the fuel mixture including a first concentration of carbon monoxide and a set of secondary materials. The electrolysis module 102 can further include a set of heating elements 130 installed within the housing and including: a stack heater 132 configured to regulate temperature of the cell stack 120 within a target stack temperature range configured to promote electrolysis; a first heat exchanger 136—defining a first side fluidly coupled to the feed inlet 142 and the cathode layer 124 and a second side fluidly coupled to the cathode layer 124 and the fuel outlet 146—configured to communicate thermal energy from the fuel mixture flowing over the first side of the heat exchanger 136 into the feed mixture flowing over the second side of the heat exchanger 136 to cool the fuel mixture and heat the feed mixture to a feed temperature within a target feed temperature range defined for the cell stack 120; and a second heat exchanger 137—defining a third side fluidly coupled to the air inlet 144 and the anode layer 126 and a fourth side fluidly coupled to the anode layer 126 and the air outlet—configured to communicate thermal energy from the oxygen mixture flowing over the third side of the second heat exchanger 137 into the air mixture flowing over the fourth side of the second heat exchanger 137 to cool the oxygen mixture and heat the air mixture to an air temperature within a target air temperature range defined for the cell stack 120. In this variation, the system 100 can further include: a power module 190 configured to drive a voltage between the cathode layer 124 and the anode layer 126 to promote electrolysis of carbon dioxide flowing over the cathode layer 124; and a controller 192 configured to selectively distribute power from the power module 190 to the set of heating elements 130 to regulate temperatures of fluid within the cell stack 120.

In one variation, the system 100 can further include a fuel processing module 160 including a separation unit 164 (e.g., a carbon dioxide separation unit) configured to receive the fuel mixture from the fuel outlet 146 and promote separation of carbon dioxide from the fuel mixture to generate a second fuel mixture including a second concentration of carbon monoxide exceeding the first concentration.

One variation of the system 100 includes: a skid 110; a feed-supply module 150 installed on the skid no and including a humidification unit 151 configured to humidify carbon dioxide flowing through the humidification unit 151 to generate a feed mixture including carbon dioxide and water; and an electrolysis module 102 configured to transiently install on the skid 110. In this variation, the electrolysis module 102 includes: a housing 140 defining a feed inlet 142, configured to couple to the feed supply module 150 to receive metered volumes of the feed mixture from the feed-supply module 150, and, an air inlet 144 configured to couple to an air-supply module 170 to receive metered volumes of an air mixture (e.g., ambient air, filtered air, oxygen-enriched air); a cell stack 120 transiently installed within the module housing 140 and including a set of reversible fuel cells 122 configured to communicate the feed mixture across a cathode layer 124 of the cell stack 120 and communicate the air mixture across an anode layer 126 of the cell stack 120 to generate a fuel mixture at the cathode layer 124 via electrolysis, the fuel mixture including syngas and a first concentration of a set of secondary materials. The cell stack 120 further includes a set of heating elements 130 installed within the housing and including: a stack heater 132 coupled to the cell stack 120 and configured to regulate temperature of the cell stack 120 within a target stack temperature range defined for the cell stack 120; and a set of heat exchangers 134 installed within the module housing 140. The set of heat exchangers 134 can be configured to: cool the fuel mixture received from the cathode layer 124; heat the air mixture, received from the air-supply module 170, to an air temperature within a target air temperature range defined by the cell stack 120; and heat the feed mixture, received from the feed-supply module 150 to a feed temperature within a target feed temperature range defined for the cell stack 120. The system 100 further includes: a power module 190 installed on the skid 110 and configured to drive a voltage across the cell stack 120; and a controller 192 configured to selectively distribute power from the power module 190 to the cell stack 120 and the set of heating elements 130 to regulate temperatures of fluid flowing through the cell stack 120.

### 3. Applications

Generally, the system 100 defines a modular electrolyzer system including a replaceable, reversible fuel cell stack 120—including a set of high-temperature, reversible solid-oxide fuel cells 122 arranged in a vertical stack and configured for replacement as a singular unit—configured to convert electrical energy into chemical energy (e.g., syngas, carbon monoxide, hydrogen, oxygen) via electrolysis of water and/or carbon dioxide; a thermally-insulated housing installed on a skid 110 and configured to receive the reversible fuel cell stack 120; a set of fluid supply modules arranged about the thermally-insulated housing (hereinafter “module housing”) on the skid 110 and configured to supply metered volumes of water and/or carbon dioxide to the reversible fuel cell stack 120; and a power module 190 configured to selectively distribute power to the reversible fuel cell stack 120 to induce a current across the reversible fuel cell stack 120 and promote generation of chemical energy via electrolysis of water and/or carbon dioxide.

In particular, the system 100 includes: an electrolysis module 102 including the reversible fuel cell stack 120 (e.g., a 1 KW solid oxide electrolyzer cell) transiently installed within the module housing and a set of heating elements configured to maintain a high-temperature profile across the reversible fuel cell stack 120 and maximize temperatures of fluids entering the cell stack 120 to promote high-efficiency electrolysis within the cell stack 120; a balance-of-plant module 104 configured regulate supply of water and/or carbon dioxide to the reversible fuel cell stack 120 and regulate processing of a fuel mixture—such as including hydrogen, carbon monoxide, oxygen, and/or water—output by the reversible fuel cell stack 120 for extraction of a target fuel (e.g., syngas, hydrogen) and/or recycling of secondary materials (e.g., water, oxygen); and a power module 190—coupled to an external power supply—configured to selectively distribute power to the electrolysis module 102 and/or the balance-of-plant module 104 to regulate flows, temperatures, pressures, etc., of fluids and/or hardware components within these modules and thus regulate electrolysis at the cell stack 120. In particular, the cell stack 120 can define a high-temperature solid oxide electrolyzer cell configured to exhibit relatively high reaction rates of electrolysis with highly-stable catalysts, thereby improving performance and/or efficiency of the cell stack 120.

These electrolysis, balance-of-plant, and power modules 190 can be installed in a singular modular skid 110—such as a 10-foot-long or 20 foot-long shipping container—and cooperate to enable conversion of electrical energy into a set of target fuels (e.g., including hydrogen and/or carbon monoxide). In particular, the skid no can be loaded with the electrolysis, balance-of-plant, and/or power modules 190 and deployed (e.g., shipped) to any location—such as within a power plant facility—to enable rapid and fully-contained (e.g., within the skid 110) generation of chemical energy with this standalone unit (i.e., skid 110), such as via coupling of the power module 190 to an external power supply within the facility. Components of the electrolysis, balance-of-plant, and power modules 190 can therefore be configured to install within a target footprint (e.g., a 20-foot long high-cube shipping container) defined by the skid 110. Therefore, the system 100 can define a particular arrangement of these modules within the skid 110 in order to minimize this target footprint and increase compactness of the system 100, while maintaining high-efficiency operation of the reversible fuel cell stack 120, achieving a target capacity defined for the cell stack 120, and maximizing longevity (e.g., a shelf life) of components of the system 100. Furthermore, by assembling these modules within a single, standalone unit (i.e., the skid 110), the system 100 can exhibit a smaller footprint, reduced complexity, and therefore enable reduced costs of assembly and/or operation.

In addition, the system 100 can be scaled according to a target capacity of the cell stack 120. For example, a first instance of the system 100 including a first set of modules installed on a first skid 110 of a first size (e.g., a 10-foot container) can define a first target capacity for the cell stack 120. A second instance of the system 100 including a second set of modules installed on a second skid 110 of second size (e.g., a 20-foot container) can define a second target capacity—exceeding the first target capacity—for a second cell stack 120 installed within the second skid no. In particular, by increasing a size of the skid 110, the system 100 can include a larger cell stack 120 and/or additional cell stacks 120 (e.g., arranged in parallel and/or in series) and therefore exhibit an increased capacity.

Additionally or alternatively, the system 100 can include a set of skids 110—each loaded with a set of electrolysis, balance-of-plant, and power modules 190—arranged in parallel and/or in series and configured to cooperate to increase an overall capacity of the system 100. For example, in a relatively small facility, the system 100 can include a single skid 110 defining a first capacity. In a relatively large facility, however, the system 100 can include an array of skids 110—each defining the first capacity—configured to combine to define a total capacity exceeding the first capacity.

Over time, these modules can be readily removed and/or replaced within the skid 110—such as for cleaning, maintenance, and/or replacement—with minimal downtime or interruption in fuel production. In particular, the electrolysis module 102—including components exposed to highest temperatures during operation, such as the cell stack 120 and the set of heating elements 130—can be configured to be removed and/or replaced as a singular unit, thereby: reducing the target life cycle of these components, reducing costs of these components, reducing complexity and/or risk for an operator during removal of these components from the skid 110.

### 3.1 Configuration: Target Fuel Generation

Furthermore, in one implementation, the system 100 can be assembled in multiple configurations, as further described below. In particular, the system 100 can be assembled in a particular configuration corresponding to a target fuel (e.g., syngas, hydrogen) output by the system 100. For example, the system 100 can be assembled in a first configuration (hereinafter a “co-electrolysis” configuration), configured to: supply metered volumes of a gaseous carbon dioxide and water mixture to the electrolysis module 102; generate a fuel mixture—including syngas (i.e., carbon monoxide and hydrogen) and other secondary materials including carbon dioxide and/or water—via electrolysis of carbon dioxide and water within a reversible fuel cell stack 120 of the electrolysis module 102; and process the fuel mixture—output by the electrolysis module 102—to extract amounts of syngas from the fuel mixture. Additionally or alternatively, the system 100 can be assembled in a second configuration (hereinafter a “water electrolysis” configuration), configured to: supply metered volumes of steam (i.e., water) to the electrolysis module 102; and output a fuel mixture—including hydrogen and other secondary materials including water—via electrolysis of water within a reversible fuel cell stack 120 of the electrolysis module 102; and process the fuel mixture output by the electrolysis module 102 to extract amounts of hydrogen (e.g., hydrogen gas) from the fuel mixture. Additionally or alternatively, the system 100 can be assembled in a third configuration (hereinafter a “carbon dioxide electrolysis” configuration) configured to: supply metered volumes of carbon dioxide to the electrolysis module 102; generate a fuel mixture—including carbon monoxide and other secondary materials including carbon dioxide—via electrolysis of carbon dioxide within a reversible fuel cell stack 120 of the electrolysis module 102; and process the fuel mixture output by the electrolysis module 102 to extract amounts of carbon monoxide from the fuel mixture.

### 3.2 Reversible Solid-Oxide Fuel Cell

The system 100 can be configured to include a reversible fuel cell stack 120 (hereinafter a “cell stack” 120)—arranged within the electrolysis module 102—including a set of reversible fuel cells 122 arranged in a vertical stack.

In one implementation, the set of reversible fuel cells 122 can define a set of reversible, solid-oxide reversible fuel cells 122 (or “RSOFCs”). In particular, an RSOFC can operate in both a reversible fuel cell 122 mode (i.e., SOFC mode), in which chemical energy (e.g., hydrogen, natural gas, hydrocarbons, syngas, carbon monoxide) is converted to electrical energy, and in an electrolysis mode (i.e., SOEC mode), in which electrical energy is converted back to chemical energy (e.g., syngas, carbon monoxide, hydrogen, oxygen) via electrolysis of water and/or carbon dioxide.

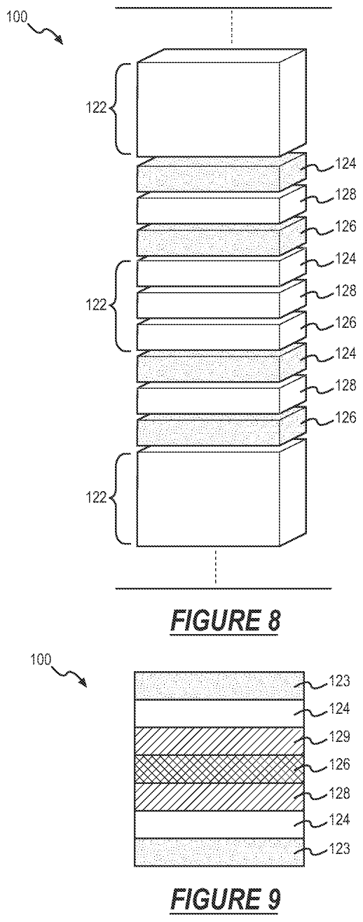

As shown in FIGS. 8 and 9, a single RSOFC cell unit can include: an electrolyte material (e.g., ScSZ electrolyte material); a cathode layer 124, arranged across a first surface of the electrolyte material; and an anode layer 126 arranged across a second surface of the electrolyte material opposite the first surface.

These individual RSOFC cell units can be arranged to form a stack (e.g., an RSOFC stack), including an interconnect 128 (e.g., Crofer 22 APU) arranged between each individual RSOFC cell unit in the cell stack 120. Each interconnect 128 thereby functions as a connector between an anode layer 126 of a first cell unit, in the cell stack 120, and a cathode layer 124 of a second cell unit, in the cell stack 120. Therefore, to improve efficiency (e.g., electrochemical efficiency) of the cell stack 120, the electrodes or interconnect 128 can be coated with a contact material—such as forming a “contact layer” 129—that enables materials (e.g., electrode and interconnect 128 materials) of the cell stack 120 to tolerate both conversion of electrical energy to chemical energy (e.g., in electrolysis mode) and vice versa (e.g., in reversible fuel cell mode).

The contact material can therefore form a contact layer 129 arranged between each interconnect 128 and each electrode in the cell stack 120 to enable compatibility (e.g., chemical, electrochemical, thermal expansion, reactivity) between: the interconnect 128 and the cathode layer 124; and the interconnect 128 and the anode layer 126. In particular, the contact material can be configured to: bond and electrically connect the interconnect 128 to the anode layer 126 of the cell stack 120; minimize delamination, deformation, and/or cell fracture issues during thermal cycling due to differences in thermal expansion properties of the contact material, interconnect and electrode materials; and enable stable electrochemical performance of the cell stack 120 (e.g., by minimizing interfacial ohmic resistance between the contact material, interconnect and electrode materials) over many cycles.

Thus, the contact material can be configured to exhibit: high electrical conductivity (e.g., greater than 250 S/cm) at relatively high operating temperatures (e.g., between 700 degrees Celsius and 1300 degrees Celsius) and thereby exhibit relatively low interfacial resistance between the electrodes and the interconnect; thermal expansion coefficients matched (e.g., within a threshold deviation of ten percent) to thermal expansion coefficients (hereinafter “TEC values”) of the interconnect 128 and electrode materials; minimal reactivity with the interconnect 128 and electrode materials; and sintering behavior matched (e.g., within a threshold deviation of twenty percent) to the interconnect 128 and electrode materials, thereby enabling strong adhesion of the contact material with the interconnect 128 and electrode materials.

Therefore, the contact material enables long-term electrochemical performance of the cell stack 120 in both the reversible fuel cell mode and electrolysis mode by: defining a highly conductive pathway for transfer of electrical energy between the electrode(s) and the interconnect 128 and thereby reducing interfacial resistance; limiting or eliminating delamination and/or corrosion at the anode layer 126 that occurs while the cell stack 120 is operated in the electrolysis mode (e.g., by increasing porosity and preventing pO₂ buildup); exhibiting chemical and structural stability within RSOFC operating conditions; and strongly bonding (e.g., physically and electrically) with both the interconnect 128 and electrode materials.

In one implementation, the contact layer 129 includes a base material (e.g., LaNiO_{3-δ}) including a first amount of Lanthanum, a second amount of Nickel, and a third amount of Oxygen. This base material can exhibit high electrical conductivity (e.g., at temperatures within a target temperature range), such that the resulting contact layer 129 exhibits relatively high electrical conductivity. For example, a contact layer 129 can be formed of a material including: a base material including a first amount of Lanthanum, a second amount of Nickel, a third amount of Oxygen; a fourth amount of a first doping agent (e.g., Iron, Cobalt) configured to stabilize the base material; and a fifth amount of a doping agent (e.g., Iron, Copper, Chromium) configured to limit thermal expansion of the base material. In this example, the contact layer 129 material exhibits: a thermal expansion coefficient between 10.0×10⁻⁶K⁻¹ and 15.0×10⁻⁶K⁻¹ at temperatures between 25 degrees Celsius and 1100 degrees Celsius; and an electrical conductivity greater than 200 Siemens-per-centimeter at temperatures within a temperature range of 700 degrees Celsius to 1300 degrees Celsius.

In particular, in one example, the contact layer 129 can include: a base material including a first amount of Lanthanum, a second amount of Nickel, a fourth amount of Oxygen, and a third amount of Iron configured to stabilize the base material. In particular, this third amount of Iron can be configured to stabilize the perovskite structure of the resulting contact layer 129 at temperatures exceeding 1000 degrees Celsius, such as during operation of the reversible fuel cell stack 120 including the contact layer 129. Additionally, in this implementation, the contact layer 129 can include a fifth amount of a doping agent—such as Copper and/or Chromium—configured to limit thermal expansion of the base material. In another example, the contact layer 129 can include: a base material including a first amount of Lanthanum, a second amount of Nickel, a fourth amount of Oxygen, and a third amount of Cobalt configured to stabilize the base material. In particular, this third amount of Cobalt can be configured to stabilize the perovskite structure of the resulting contact layer 129 at temperatures exceeding 1000 degrees Celsius, such as during operation of a fuel cell stack 104 including the contact layer 129. Additionally, in this implementation, the contact layer 129 can include a fifth amount of a doping agent—such as Iron, Copper, and/or Chromium—configured to limit thermal expansion of the base material.

### 4. Skid: Electrolysis Module+Balance-of-Plant Module

The system 100 can include a skid 110 configured for deployment to an industrial facility, such as a power plant and/or manufacturing facility. In particular, the skid 110 can be configured to: support and locate an electrolysis module 102, a balance-of-plant module 104, and/or a set of infrastructure modules; and transiently (e.g., temporarily, semi-permanently) and/or permanently install within an industrial facility.

In one implementation, the skid 110 can include: a chassis or frame—defining a set of module slots 112 configured to be loaded with the electrolysis module 102, balance-of-plant module 104, and/or the set of infrastructure modules; and/or a skid housing 114—defining a target footprint—arranged about and/or coupled to the skid 110. In this implementation, the skid housing 114 of the skid 110 can include a vent configured to enable release of gas from within the skid housing 114 and therefore reduce risk of system 100 failure due to overheating and/or pressure buildup within the skid 110.

### 4.1 Infrastructure

The system 100 can include a set of infrastructure modules configured to support infrastructure-type functions at the balance-of-plant module 104 and/or the electrolysis module 102, such as power supply, regulated air pressure supply, heating and/or cooling, communications, etc.

In one implementation, the set of infrastructure modules can be configured to be transiently installed within the skid 110 and later removed from the skid no, such as for servicing and/or if the skid no is redeployed to a different environment. Additionally or alternatively, in another implementation, some or all of these infrastructure modules can be integrated (i.e., permanently installed) into the skid 110. Additionally or alternatively, in yet another implementation, some or all of these infrastructure modules can be removed from the skid no and instead coupled to the skid no from an external source (e.g., within a power plant or manufacturing facility), thereby preserving space within the skid no.

### 4.1.1 Power Module

The system 100 can include a set of power module 190s configured to supply power to the electrolysis module 102 and/or the balance-of-plant module 104. In particular, the system 100 can include a power module 190 installed on the skid 110; configured to couple to an external power supply

In one example, the system 100 can include a first power module 190 including: a rectifier (e.g., a 3-phase rectifier) electrically coupled to an external power source and configured to convert 3-phase power supply received from the external power source to a DC power supply; and a converter (e.g., a DCDC converter)—electrically coupled to the rectifier—configured to feed variable DC power received from the rectifier to the cell stack 120. In this example, the first power module 190 can also be configured to supply power to the balance-of-plant module 104. Alternatively, the system 100 can include a second power module 190—coupled to the external power source—configured to supply power to the balance-of-plant module 104.

In one implementation, the system 100 can include a power module 190 installed on the skid 110 and configured to selectively distribute power to the cell stack 120 of the electrolysis module 102 in order to drive a voltage between the cathode and the anode of each cell in the cell stack 120. Additionally or alternatively, in another implementation, the power module 190 can be configured to selectively distribute power to components of the electrolysis module 102 and/or the balance-of-plant module 104—such as a set of heating elements 130, a set of motors, a set of flow and/or pressure regulators, etc.—installed in the balance of plant module and/or electrolysis module 102 in order to regulate capacity and/or efficiency of the cell stack 120.

### 4.1.2 Controller

The system 100 can include a controller 192 configured to monitor operating conditions within the skid 110 and selectively actuate components of the balance-of-plant, electrolysis, and/or power module 190s based on these operating conditions.

In particular, the controller 192 can track a set of operating controls—such as flowrates, temperatures, pressures, etc.—within the balance-of-plant module 104 and/or the electrolysis module 102, such as based on signals output by a set of sensors 116 installed on the skid 110 and/or within these modules; and—based on the set of operating controls—selectively trigger the set of power module 190s to distribute power to components of the balance-of-plant and/or electrolysis module 102; selectively regulate flow and/or amounts of materials circulating within the balance-of-plant and/or electrolysis module 102 via actuation of a set of flow controllers (e.g., mass flow controller, solenoid valve, isolation valve) and/or pressure regulators (e.g., electronic pressure regulator); selectively regulate temperatures of components within the balance-of-plant module 104 and/or the electrolysis module 102, such as via heating elements 130 (e.g., heaters, heat exchangers 134) installed within the skid 110; etc.

For example, the controller 192 can monitor and regulate these operating controls in order to maintain a cell stack 120 capacity exceeding a threshold capacity (e.g., 0.5 kilowatts, one kilowatt, ten kilowatts, 100 kilowatts). Additionally or alternatively, in another example, the controller 192 can monitor and regulate these operating controls in order to maintain an efficiency exceeding a threshold efficiency (e.g., 50 percent, 70 percent, 90 percent).

In one variation, the skid 110 can include a set of sub-controller 192s configured to locally regulate distribution of metered volumes of fluid (e.g., carbon dioxide gas, water and/or steam, hydrogen gas, air), temperature and/or pressure controls, etc. For example, the electrolysis module 102 can include a first sub-controller 192 configured to regulate power supply to the cell stack 120—and thereby regulate a magnitude of a current applied across reversible fuel cells 122 within the cell stack 120—and/or to the set of heating elements 130 (e.g., heat exchangers 134, stack heater 132) within the electrolysis module 102. In this example, the balance-of-plant module 104 can include a second sub-controller 192 configured to regulate power supply to the feed supply and/or fuel processing assemblies of the balance-of-plant module 104. Additionally or alternatively, in another example, the balance-of-plant module 104 can include a set of sub-controller 1925 including: a first sub-controller 192 configured to regulate release of metered volumes of the feed mixture into the electrolysis module 102 via actuation of one or more flowmeters; a second sub-controller 192 configured to regulate temperature of water stored in the water tank 155 via selective actuation of a heating element (e.g., a heater) coupled to the water tank 155; a third sub-controller 192 configured to regulate flow of metered volumes air into the electrolysis module 102 via actuation of a compressor 172 (e.g., an air blower) of the air-supply module 170; and/or a fourth sub-controller 192 configured to regulate actuation of the dryer unit 162 (e.g., a compressed air dryer) of the fuel-processing module 160.

### 4.2 Sensors

The system 100 can include a suite of sensors 116 configured to capture control data—such as temperature, pressure, volumetric and/or mass flows, concentration, and/or depth data—representative of a set of operating controls at the balance-of-plant, electrolysis, and/or power module 190s. For example, the system 100 can include: a set of temperature sensors 116 configured to capture temperature data for fluids circulating within the balance-of-plant module 104 and/or the electrolysis module 102 and/or for hardware components within these modules; a set of pressure sensors 116 configured to capture pressure data for fluids circulating within the balance-of-plant module 104 and the electrolysis module 102; and/or a set of flow sensors 116 (e.g., flow meters) configured to capture flow data (e.g., flow rates) of fluids circulating within the balance-of-plant module 104 and the electrolysis module 102.

Additionally or alternatively, in one implementation, the system 100 can include a set of air sensors 116 configured to capture air composition data representative of a composition of ambient air within the skid housing 114. For example, the system 100 can include: a smoke sensor configured to output a signal representative of a concentration of smoke or particulate in ambient air within the skid housing 114; and/or a hydrogen sensor configured to output a signal representative of a concentration of hydrogen gas in ambient air within the skid housing 114. The controller 192 can then leverage these signals to interpret presence of particles, gases, and/or any hazardous materials in ambient air within the skid housing 114. For example, the controller 192 can: read a first signal output by the smoke sensor and interpret a smoke level within the skid housing 114; and read a second signal output by the hydrogen sensor and interpret a concentration of hydrogen in ambient air within the skid housing 114.

### 5. Electrolysis Module

The system 100 can include an electrolysis module 102 installed (e.g., transiently, semi-permanently, and/or permanently installed) on the skid 110. The electrolysis module 102 can be configured to: ingest a feed mixture—including a set of target gases (e.g., water, carbon dioxide)—and an air mixture (e.g., ambient air, filtered air, oxygen-enriched air); and output a fuel mixture including a set of target fuels—including hydrogen and/or carbon monoxide—via electrolysis of the set of target gases.

In one implementation, the electrolysis module 102 can include: a housing (e.g., a thermally-insulated housing); a cell stack 120—including a set of reversible fuel cells 122 arranged in a vertical stack—arranged within the housing; and a set of heating elements 130 configured to regulate temperature of components of the electrolysis module 102 to enable electrolysis—such as at a target efficiency and/or target capacity—of the feed mixture to generate the fuel mixture.

### 5.1 SOEC Module Housing

The system 100 can include an electrolysis module housing 140 (hereinafter “module housing”) configured to house the cell stack 120 and components of the electrolysis module 102.

In particular, the electrolysis module 102 can include a module housing 140 configured to thermally isolate components of the electrolysis module 102 arranged within an interior volume of the module housing 140—including one or more cell stacks 120, the set of heat exchangers 134, and/or cathode and anode supply ducts—from an exterior of the module housing 140.

For example, the module housing 140 can include a layer of thermal insulation applied to interior and/or exterior walls of the module housing 140. In particular, the module housing 140 can include an insulation layer 141 applied to surfaces of the housing and configured to limit heat loss from an interior of the housing to an exterior of the housing. By including this layer of thermal insulation, the module housing 140 can be configured to: retain heat generated within the interior volume of the module housing 140 by the set of heat exchangers 134 and/or the set of cell stacks 120 and therefore reduce energy costs due to reduction in heat loss; and regulate temperatures of components of the system 100 external the module housing 140 within target temperature ranges less than temperatures of the interior volume of the module housing 140, and thereby reduce risk of human injury due to excessive heating of exposed components of the system 100 and/or due to overheating of stored gases (e.g., carbon dioxide, hydrogen).

In one implementation, the module housing 140 defines a set of inlets and a set of outlets configured to enable entry and exit of fluids from the module housing 140. In particular, the module housing 140 can define: a feed inlet 142 configured to receive the feed mixture from the feed-supply module 150; a fuel outlet 146 fluidly coupled to the feed inlet 142 (e.g., downstream the cell stack 120) and configured to output the fuel mixture to the fuel-processing module 160; an air inlet 144 configured to receive the air mixture from the air-supply module 170; and an air outlet 148 fluidly coupled to the air inlet 144 (e.g., downstream the cell stack 120). For example, the module housing 140 can define: a feed inlet 142 fluidly coupled to a feed inlet duct configured to direct fluid from the feed inlet 142 toward a cathode layer 124 of a reversible fuel cell 122 in the cell stack 120; a fuel outlet 146 fluidly coupled to a fuel outlet duct configured to direct fluid exiting the cathode layer 124 of the reversible fuel cell 122 toward the fuel outlet 146 for release from the module housing 140; an air inlet 144 fluidly coupled to an air inlet duct configured to direct air from the air inlet 144 toward the anode layer 126 of the reversible fuel cell 122 in the reversible fuel cell 122 stack 120; and an air outlet 148 fluidly coupled to an air outlet duct configured to direct fluid exiting the anode layer 126 of the reversible fuel cell 122 toward the air outlet 148 for release from the module housing 140.

In one implementation, the module housing 140 can define a fixed unit geometry (e.g., dimension, size, shape) configured to reduce a footprint of the electrolysis module 102 and/or of the skid 110.

### 5.2 Cell Stack

Generally, the electrolysis module 102 includes a cell stack 120 (i.e., a reversible fuel cell stack) including a set of reversible fuel cells 122 (e.g., solid oxide electrolysis cells) configured to convert electrical energy into chemical energy (e.g., syngas, carbon monoxide, hydrogen, oxygen) via electrolysis of water and/or carbon dioxide.

The cell stack 120 can include a set of reversible fuel cells 122, each reversible fuel cell 122, in the set of reversible fuel cells 122, including an electrolyte layer 123, a cathode layer 124 arranged across the electrolyte layer 123, and an anode layer 126 arranged across the electrolyte layer 123 opposite the cathode layer 124, as described above. The cell stack 120 can further define: a cathode channel fluidly coupled to the feed inlet 142 and the fuel outlet 146 and configured to communicate the feed mixture from the feed inlet 142 across one or more cathode layers 124 in the cell stack 120; and an anode channel coupled to the air inlet 144 and the air outlet 148 and configured to communicate the air mixture from the air inlet 144 across one or more anode layers 126 in the cell stack 120.

The system 100 and/or the cell stack 120 can therefore be configured to: communicate a feed mixture—such as including water and/or carbon dioxide—across the cathode layer 124 within the cathode channel; communicate an air mixture—including ambient air, filtered air, and/or oxygen-enriched air—across the anode layer 126 within the anode channel; output a fuel mixture—including a set of target fuels (e.g., hydrogen, carbon monoxide) and secondary materials (e.g., water, carbon dioxide) from the cathode layer 124; and output an oxygen mixture (e.g., an oxygen-enriched air mixture) from the anode layer 126.

In one implementation, the cell stack 120 can include multiple reversible fuel cells 122 arranged in a vertical stack. In particular, in this implementation, the cell stack 120 can include: a set of reversible fuel cells 122 (e.g., “x” number of reversible fuel cells 122) arranged in a vertical stack; and a set of interconnects 128 (e.g., “x−1” number of interconnects 128) interposed between adjacent reversible fuel cells 122 in the set of reversible fuel cells 122. For example, the cell stack 120 can include a set of twenty reversible fuel cells 122—each reversible fuel cell 122 including a cathode layer 124, an anode layer 126, and an electrolyte layer 123 interposed between the cathode layer 124 and the anode layer 126—and a set of nineteen interconnects 128 interposed between adjacent reversible fuel cells 122 in the set of twenty reversible fuel cells 122. In another example, the cell stack 120 can include a set of 100 reversible fuel cells 122 and a set of 99 interconnects 128 interposed between adjacent reversible fuel cells 122 in the set of 100 reversible fuel cells 122.

In particular, the cell stack 120 can include a set of reversible fuel cells 122 including: a first fuel cell; a second reversible fuel cell 122 arranged above and coupled to the first fuel cell; and a first interconnect 128 interposed between the first and second fuel cell. The first reversible fuel cell 122 can include: a first electrolyte layer 123; a first cathode layer 124 arranged across an upper surface of the first electrolyte layer 123; and a first anode layer 126 arranged across a lower surface—opposite the upper surface—of the first electrolyte layer 123. The second reversible fuel cell 122—arranged above and coupled to the first reversible fuel cell 122—can include: a second electrolyte layer 123; a second cathode layer 124 arranged across an upper surface of the second electrolyte layer 123; and a second anode layer 126 arranged across a lower surface—opposite the upper surface—of the second electrolyte layer 123. The cell stack 120 can further include a first interconnect 128 interposed between the first anode layer 126 of the first reversible fuel cell 122 and the second cathode layer 124 of the second fuel cell.

Additionally, in this implementation, the cell stack 120 can further include: a third reversible fuel cell 122 arranged above and coupled to the second reversible fuel cell 122 and a second interconnect 128 interposed between the second and third reversible fuel cells 122; a fourth reversible fuel cell 122 arranged above and coupled to the third reversible fuel cell 122 and a third interconnect 128 interposed between the third and fourth reversible fuel cells 122; etc.

### 5.2.1 Stack Arrangement

The electrolysis module 102 can include a set of cell stacks 120 arranged within the module housing 140.

In one implementation, the electrolysis module 102 can include a single cell stack 120 including a set of reversible fuel cells 122 configured to convert electrical energy into chemical energy (e.g., syngas, carbon monoxide, hydrogen, oxygen) via electrolysis of water and/or carbon dioxide.

Additionally or alternatively, in another implementation, the electrolysis module 102 can include multiple cell stacks 120 arranged in series, thereby increasing efficiency of the electrolysis module 102. For example, the module housing 140 can define a set of stack receptacles—configured to receive a set of cell stacks 120—including a first stack receptacle and a second stack receptacle. In this example, the electrolysis module 102 can include: a first cell stack 120 configured to install (e.g., transiently install) within the first stack receptacle; and a second cell stack 120 configured to install (e.g., transiently install) within the second stack receptacle. The first cell stack 120—including a first set of reversible fuel cells 122 arranged in a vertical stack—can be configured to: receive the feed mixture from the feed inlet 142 of the module housing 140; receive the air mixture from the air inlet 144; and communicate the feed mixture across one or more cathode layers 124 of the first cell stack 120—and communicate the air mixture across one or more anode layers 126 of the first cell stack 120—to generate the fuel mixture including a first concentration of a target gas (e.g., syngas, carbon monoxide, hydrogen) and a set of secondary materials (e.g., carbon dioxide, water. Then, the second cell stack 120—arranged in series and/or fluidly coupled to the first cell stack 120—can be configured to: receive the fuel mixture from the first cell stack 120; and communicate the fuel mixture across one or more cathode layers 124 of the second cell stack 120—and communicate the air mixture, including oxygen-enriched air, received from the first cell stack 120 across one or more anode layers 126 of the second cell stack 120—to convert secondary materials in the fuel mixture into the target gas and therefore generate a second fuel mixture including a second concentration, exceeding the first concentration, of the target gas. The electrolysis module 102 can similarly include a third cell stack 120 fluidly coupled to the second cell stack 120, a fourth cell stack 120 fluidly coupled to the third cell stack 120, etc.

Additionally or alternatively, in another implementation, the electrolysis module 102 can include multiple cell stacks 120 arranged in parallel. In this implementation, by arranging the cell stacks 120 in parallel, the controller 192 can selectively activate and/or deactivate a subset of cell stacks 120, in the set of cell stacks 120, based on defined target capacities and/or target efficiencies. Further, in response to removal of one or more cell stacks 120 from the electrolysis module 102—such as due to decreased efficiency of these cell stacks 120—the system 100 can continue operations at a remaining set of cell stacks 120 within the electrolysis module 102.

### 5.3 Heating Elements

The electrolysis module 102 can include a set of heating elements 130 configured to regulate temperature of components (e.g., cell stack 120, cathode ducts, anode ducts) within the module housing 140 and/or fluid streams (e.g., carbon dioxide, hydrogen, air) flowing through these components.

In one implementation, the electrolysis module 102 can include a stack heater 132 arranged within the module housing 140 and coupled to the cell stack 120. The stack heater 132 can be configured to regulate a temperature of the cell stack 120 within a target temperature range defined for the cell stack 120. For example, the stack heater 132 can be configured to regulate the temperature of the cell stack 120 between Boo degrees Celsius and 1000 degrees Celsius.

Additionally or alternatively, the electrolysis module 102 can include a set of heat exchangers 134 configured to regulate temperature of fluid streams (e.g., carbon dioxide, hydrogen, air) circulating within the module housing 140. In one implementation, the electrolysis module 102 can include a set of heat exchangers 134 including: a feed heat exchanger 136 interposed between the feed inlet duct and the fuel outlet duct and configured to transfer heat from the fuel mixture (e.g., syngas, carbon monoxide, hydrogen)—flowing through the fuel outlet duct—into the feed mixture (e.g., water, carbon dioxide) flowing through the feed inlet duct; and/or an air heat exchanger 137 interposed between the air inlet duct and the air outlet duct and configured to transfer heat from oxygen-enriched air (or the “oxygen mixture”)—flowing through the air outlet duct—into air flowing through the air inlet duct. Therefore, the feed heat exchanger 136 can be configured to heat the feed mixture upon entry into the module housing 140—prior to circulation through the cell stack 120—and cool the fuel mixture exiting the cell stack 120 prior to release from the module housing 140. The air heat exchanger 137 can be configured to heat air upon entry into the module housing 140—prior to circulation through the cell stack 120—and cool the oxygen mixture (e.g., oxygen-enriched air) exiting the cell stack 120 prior to release from the module housing 140.

Additionally or alternatively, in another implementation, the electrolysis module 102 can further include a fuel-air heat exchanger 138 interposed between the air inlet duct and the fuel outlet duct and configured to transfer heat from air—flowing through the air inlet duct—into the fuel mixture flowing through the fuel outlet duct. In this implementation, the fuel-air heat exchanger 138 can be coupled to the air inlet duct upstream the second heat exchanger, such that air heat exchanger 137 can reheat air—cooled via the fuel-air heat exchanger 138—prior to entry through the cell stack 120.

In one example, the electrolysis module 102 can include: a fuel-air heat exchanger 138 configured to extract thermal energy from fluid flowing over a first side of the fuel-air heat exchanger 138 and release thermal energy into fluid flowing over a second side of the fuel-air heat exchanger 138; a feed heat exchanger 136 configured to extract thermal energy from fluid flowing over a third side of the feed heat exchanger 136 and release thermal energy into fluid flowing over a fourth side of the feed heat exchanger 136; and/or an air heat exchanger 137 configured to extract thermal energy from fluid flowing over a fifth side of the air heat exchanger 137 and release thermal energy into fluid flowing over a sixth side of the air heat exchanger 137.

In this example, the system 100 can further include: a feed duct fluidly coupled to the feed inlet 142 and the cathode layer 124; a fuel duct fluidly coupled to the cathode layer 124 and the fuel outlet 146; an air duct fluidly coupled to the air inlet 144 and the anode layer 126; and an oxygen duct fluidly coupled to the anode layer 126 and the air outlet 148. The feed duct can be configured to: communicate (e.g., convey, pass) the feed mixture from the feed inlet 142 across the fourth side of the feed heat exchanger 136 to heat the feed mixture to a feed temperature within a target feed temperature range; and communicate the feed mixture from the feed heat exchanger 136 to the cathode channel and/or cathode layer 124. The fuel duct can be configured to: communicate the fuel mixture from the cathode channel across the third side of the feed heat exchanger 136 to cool the fuel mixture; communicate the fuel mixture from the feed heat exchanger 136 across the first side of the fuel-air heat exchanger 138 to cool the fuel mixture; and communicate the fuel mixture from the fuel-air heat exchanger 138 to the fuel outlet 146. The air duct can be configured to: communicate the air mixture from the air inlet 144 across the second side of the fuel-air heat exchanger 138 to heat the air mixture; communicate the air mixture from the fuel-air heat exchanger 138 to the sixth side of the air heat exchanger 137 to heat the air mixture to an air temperature within a target air temperature range; and communicate the air mixture from the air heat exchanger 137 to the anode channel and/or anode layer 126. Finally, the oxygen duct can be configured to: communicate the oxygen mixture (e.g., oxygen-enriched air) from the anode channel across the fifth side of the air heat exchanger 137 to cool the oxygen mixture; and communicate the oxygen mixture from the air heat exchanger 137 to the air outlet 148.

For example, the system 100 can: convey the feed mixture across a first side of the feed heat exchanger 126 to heat the feed mixture from a first feed temperature at a first heat exchanger inlet to a second feed temperature, within a target feed temperature range, at a first heat exchanger outlet, the second feed temperature exceeding the first feed temperature (e.g., during a heating cycle) in Block S112; and convey the fuel mixture from the cell stack over a second side of the feed heat exchanger 136 to cool the fuel mixture from a first fuel temperature at a second heat exchanger inlet to a second fuel temperature at a second heat exchanger outlet, the second fuel temperature falling below the first fuel temperature (e.g., during a cooling cycle) in Block S132. Additionally or alternatively, the system 100 can: convey the fuel mixture from the feed heat exchanger 136 outlet over a first side of a fuel-air heat exchanger 138 to cool the fuel mixture from the second fuel temperature at a third heat exchanger inlet to a third fuel temperature at a third heat exchanger outlet, the third fuel temperature falling below the second fuel temperature in Block S134; and convey the air mixture from the air supply module 170 over a second side of the fuel-air heat exchanger 138 to heat the air mixture from a first air temperature at a fourth heat exchanger inlet to a second air temperature at a fourth heat exchanger outlet within a target air temperature range, the second air temperature exceeding the first air temperature in Block S122. Additionally or alternatively, the system 100 can further: convey the air mixture from the air supply module 170—and/or from the fuel-air heat exchanger 138—over a first side of an air heat exchanger 137 to heat the air mixture from the second air temperature at a third heat exchanger inlet to a second air temperature at a third heat exchanger outlet within a target air temperature range, the second air temperature exceeding the first air temperature in Block S124; and convey the oxygen mixture from the cell stack over a second side of the air heat exchanger 137 to cool the air mixture from a third air temperature at a fourth heat exchanger inlet to a fourth air temperature at a fourth heat exchanger outlet, the fourth air temperature falling below the third air temperature in Block S136.

### 5.4 Multiple Electrolysis Modules

In one implementation, the system 100 can include multiple electrolysis modules 102, each electrolysis module 102 configured to transiently install within the skid during a particular time period, such that the electrolysis module 102 can be replaced over time as a singular unit. For example, the skid 110 can define a first module slot—such as defining a volume or set of dimensions corresponding to a volume or set of dimensions of the module housing 140—configured to receive an electrolysis module 102 in a set of electrolysis modules 102. In this example, the system 100 can include: a first electrolysis module 102, in a set of electrolysis modules 102, configured to install within the first module slot during a first time period; and a second electrolysis module 102, in the set of electrolysis modules 102, configured to install within the first module slot during a second time period (e.g., succeeding the first time period) in replacement of the first electrolysis module 102. Additionally, the system 100 can further include: a third electrolysis module 102, in the set of electrolysis modules 102, configured to install within the first module slot during a third time period; a fourth electrolysis module 102, in the set of electrolysis modules 102, configured to install within the first module slot during a fourth time period; etc.

In the preceding example, each electrolysis module 102, in the set of electrolysis modules 102, can include: a module housing 140 defining a feed inlet 142, an air inlet 144, a fuel outlet 146, and an air outlet 148; a cell stack 120 including a set of reversible fuel cells 122; and a set of heating elements 130—such as including a stack heater 132 and/or a set of heat exchangers 134—configured to regulate temperature of the cell stack 120 and/or temperature of fluids circulating within the electrolysis module 102, as described above. Furthermore, in one example, each electrolysis module 102, in the set of electrolysis modules 102, can include a set of connectors (e.g., electrical connectors) coupled (e.g., electrically coupled) to the cell stack 120 (e.g., extending through the module housing 140) and configured to transiently engage a set of connector receivers to electrically couple the cell stack 120 to the power module 190.

Additionally or alternatively, in another implementation, the system 100 can include multiple electrolysis modules 102 configured to concurrently install on the skid 110. For example, the skid 110 can define a set of module slots including a first module slot and a second module slot. The system 100 can include a set of electrolysis modules 102 including: a first electrolysis module 102 configured to install (e.g., transiently install) within the first module slot; and a second electrolysis module 102 configured to install (e.g., transiently install) within the second module slot. In this example, the system 100 can be configured to supply volumes of the feed mixture to both the first electrolysis module 102 and the second electrolysis module 102 for generation of the fuel mixture. In particular, in this example, the first electrolysis module 102 can include a first module housing 104 defining: a first feed inlet 142 configured to ingest a first volume of the feed mixture received from the feed-supply module 150; and a first air inlet 144 configured to ingest a second volume of an air mixture received from the air-supply module 170. The second electrolysis module 102 can include a second module housing 104 defining: a second feed inlet 142 configured to ingest a third volume of the feed mixture received from the feed-supply module 150; and a second air inlet 144 configured to ingest a fourth volume of the air mixture received from the air-supply module 170. The system 100 can be configured to selectively direct fluid from the feed-supply module 150 to a particular electrolysis module 102, in the set of electrolysis modules 102, in order to maximize efficiency of fuel generation and/or minimize downtime due to replacement or maintenance of a particular electrolysis module 102 in the set of electrolysis modules 102.

### 6. Balance-of-Plant Module

The system 100 can include a balance-of-plant module 104 configured to: supply metered volumes of a feed mixture (e.g., a gaseous mixture) including a set of target gases—such as including water, carbon dioxide, and/or hydrogen—to the electrolysis module 102 for passing to the cathode layer 124 of the cell stack 120; supply metered volumes of an air mixture—such as including ambient air, filtered air, and/or oxygen-enriched air—to the electrolysis module 102 for passing to the anode layer 126 of the cell stack 120; and receive volumes of the fuel mixture—including a set of target fuels (e.g., hydrogen and/or carbon monoxide and a set of secondary materials (e.g., water, carbon dioxide)—for extraction and/or collection of the set of target fuels from the fuel mixture.

In particular, in one implementation, the balance-of-plant module 104 can include: a feed-supply module 150 configured to supply metered volumes of the feed mixture to the electrolysis module 102 (e.g., via the feed inlet 142 of the module housing 140); an air-supply module 170 configured to supply metered volumes of the air mixture to the electrolysis module 102 (e.g., via the air inlet 144 of the module housing 140); and a fuel-processing module 160 configured to receive volumes of the fuel mixture from the electrolysis module 102 (e.g., via the fuel outlet 146 of the module housing 140) for further processing of materials present in the fuel mixture.

### 6.1 Feed-Supply Module

The balance-of-plant module 104 can include a feed-supply module 150 configured to supply the feed mixture to the electrolysis module 102. In particular, the feed-supply module 150 can include: a gas supply assembly 152 configured to selectively supply metered volumes of a target gas (e.g., hydrogen and/or carbon dioxide)—to the electrolysis module 102; and a water supply assembly 154 configured to supply metered volumes of water (e.g., steam) to the electrolysis module 102.

In one implementation, the gas supply assembly 152 can include a set of flow controllers (e.g., mass flow controllers), a set of pressure regulators, and/or a set of fluid valves configured to regulate flow and/or pressure of the target gas delivered to the electrolysis module 102. For example, the gas supply assembly 152 can include: a gas inlet duct configured to receive volumes of a target gas (e.g., hydrogen, carbon dioxide) from an external gas supply; an isolation valve (e.g., a high-pressure isolation valve) coupled to the gas inlet duct and configured to regulate flow of the target gas from the external gas supply into the gas inlet duct; a pressure regulator (e.g., an electronic pressure regulator) coupled to the gas inlet duct and configured to regulate pressure of the target gas—received from the isolation valve—to within a target pressure range; and a solenoid valve—including an integrated mass flow controller—coupled to the gas inlet duct and configured to regulate a volume of the target gas—received form the pressure regulator—supplied to the electrolysis module 102 (e.g., fluidly coupled to the gas inlet duct).

The water supply assembly 154 can include: a water tank 155—configured to store a volume of water (e.g., within the skid housing 114)—fluidly coupled to an external water supply; and a set of flow controllers (e.g., mass flow controllers), a set of pressure regulators, and/or a set of fluid valves configured to regulate flow and/or pressure of water supplied to the water tank 155 and fed to the electrolysis module 102 from the water tank 155. Further, in one variation, the water supply assembly 154 can include a water return configured to recycle water extracted from the fuel mixture in the fuel-processing module 160 back to the water tank 155. In this variation, the system 100 can therefore convey water extracted from the fuel mixture in the fuel-processing module 160 (e.g., in the dryer unit 162) to the water tank 155 via the water return.

### 6.2 Air-Supply Module

The balance-of-plant module 104 can include an air-supply module 170 configured to supply metered volumes of an air mixture (e.g., air, filtered air, and/or oxygen-enriched air) to the electrolysis module 102. In particular, the air-supply module 170 can be configured to pass metered volumes of an air mixture—including oxygen, nitrogen, and/or other secondary materials (e.g., carbon dioxide, argon)—to the air inlet 144 of the module housing 140 in Block S120.

In one implementation, the air-supply module 170 can include a compressor 172 configured to pressurize the air mixture to achieve a target flow rate of the air mixture fed to the electrolysis module 102 from the air-supply module 170. In particular, the air-supply module 170 can include a compressor 172: defining a compressor inlet and a compressor outlet; and configured to selectively increase pressure of air flowing from the compressor inlet to the compressor outlet to regulate an air flow rate of air entering the electrolysis module 102. In this implementation, the air inlet 144 of the module housing 140 can be configured to receive metered volumes of the air mixture from the compressor outlet.

The air-supply module 170 can further include: an air filter fluidly coupled to the compressor inlet and configured to remove impurities from the air mixture; a flow sensor—upstream the compressor 172—configured to output a signal representing flow of the air mixture; and a motor mechanically coupled to the compressor 172 and configured to selectively drive the blower based on the signal output by the mass flow sensor. For example, the air-supply module 170 can include: an air duct configured to receive volumes of an air mixture (e.g., ambient air, filtered air, oxygen-enriched air) from an external air supply; a mass flow sensor coupled to the air duct and configured to capture data representing mass flow of the air mixture through the air duct; a compressor 172—defining a compressor inlet and a compressor outlet—configured to regulate an air pressure of the air mixture from an air inlet pressure at the compressor inlet to an air outlet 148 pressure, exceeding the air inlet pressure, at the compressor outlet; and a motor—mechanically coupled to the compressor 172—configured to drive the compressor 172 at a particular speed or rate based on mass flow data captured by the mass flow sensor. The air-supply module 170 can therefore regulate flow of the air mixture into the electrolysis module 102 by selectively varying operation of the compressor 172 to achieve a particular air flow rate into the electrolysis module 102.

### 6.3 Fuel-Processing Module

The balance-of-plant module 104 can include a fuel-processing module 160 configured to receive volumes of the fuel mixture from the electrolysis module 102 (e.g., via the fuel outlet 146 of the module housing 140) for further processing of materials present in the fuel mixture. In particular, the fuel-processing module 160 can be configured to receive a volume of the fuel mixture (e.g., including hydrogen, carbon monoxide, and/or secondary materials)—generated via electrolysis of the feed mixture within the cell stack 120—from the electrolysis module 102; and remove secondary materials (e.g., carbon dioxide, water) present in the fuel mixture to generate (e.g., extract) a purified fuel mixture exhibiting a higher concentration of one or more target fuel products (e.g., syngas, hydrogen, carbon monoxide).

Generally, the fuel-processing module 160 can include a set of separation units configured to reduce a concentration of secondary materials—including water and/or carbon dioxide—present in the fuel mixture output by the electrolysis module 102 and therefore increase a concentration of a target fuel (e.g., syngas, carbon monoxide, hydrogen) present in the fuel mixture.

In one implementation, the fuel-processing module 160 can include: a water separation unit 162 fluidly coupled to the fuel outlet 146 of the module housing 140 and configured to reduce a concentration of water present in the fuel mixture (e.g., received from the electrolysis module 102); and/or a carbon dioxide separation unit 164 fluidly coupled to an outlet of the water separation unit 162 and configured to reduce a concentration of carbon dioxide present in the fuel mixture (e.g., received from the dryer outlet). The water separation unit 162 (or “dryer unit”) (e.g., a compressed air dryer) can be configured to: compress the fuel mixture to reduce a dew point of gases (e.g., hydrogen, carbon monoxide) present in the fuel mixture; and then separate water from this compressed fuel mixture (e.g., a gaseous mixture).

For example, the balance-of-plant module 104 can include a dryer unit 162 (e.g., a dryer, a condenser)—configured to receive the fuel mixture from the electrolysis module 102—including: a condenser and/or dryer configured to condense the fuel mixture to promote condensation of (liquid) water from the gaseous fuel mixture and thus reduce a dew point of the fuel mixture; and a water separator (e.g., a centrifugal water separator) configured to separate liquid water from the gaseous fuel mixture.

Additionally or alternatively, in another example, the balance-of-plant module 104 can include a carbon dioxide separator unit 164 configured to extract carbon dioxide from the fuel mixture and therefore increase a concentration of the target fuel (e.g., syngas, carbon monoxide, hydrogen) in the fuel mixture. For example, the balance-of-plant module 104 can include an absorber unit configured to absorb carbon dioxide from the fuel mixture to increase the concentration of the target fuel and decrease concentration of secondary materials in the fuel mixture. Alternatively, in another example, the balance-of-plant module 104 can include a high-pressure unit configured to separate carbon dioxide in the fuel mixture from the target fuel (e.g., syngas, carbon monoxide, hydrogen) via pressure swing adsorption to increase the concentration of the target fuel and decrease concentration of secondary materials in the fuel mixture dryer unit 162 dryer unit 162).

### 6.4 Oxygen-Recycle Module

In one variation, the system 100 can include an oxygen-recycle module 180 configured to return oxygen-enriched air—collected at the anode layer of the cell stack—to the air supply for feeding back into the cell stack during a subsequent electrolysis cycle. For example, the oxygen-recycle module 180 can include an air buffer tank fluidly coupled to the air outlet of the module housing 140 and the external air supply. The system wo can therefore mix incoming air—from the external air supply—with oxygen-enriched air (or “the oxygen mixture”) generated at the anode layer of the cell stack. The air-supply module can then supply metered volumes of this air mixture from the air buffer tank to the anode layer. By thus increasing an amount of oxygen present in the air mixture, the system 100 can increase performance (e.g., efficiency) of the cell stack system 100.

In one implementation, the electrolysis module 102 is configured to: generate the fuel mixture via electrolysis of the feed mixture within the cathode channel; and generate an oxygen mixture of oxygen-enriched air—including a greater concentration of oxygen than the air mixture supplied to the anode channel—within the anode channel. The oxygen-recycle module 180 can then receive the oxygen mixture from the air outlet—fluidly coupled to an outlet of the anode channel—of the module housing 140 in Block S150, and communicate the oxygen mixture (e.g., via a return duct) to an air supply tank of the air supply module 170 in Block S152, such as an air supply tank arranged on the skid no and/or external the skid 110.

### 7. Co-Electrolysis Configuration

In one implementation, as shown in FIG. 1, the system 100 can be configured to convert metered volumes of a feed mixture including carbon dioxide and water (e.g., steam) into volumes of a fuel mixture including hydrogen gas and carbon monoxide gas (or “syngas”) in a co-electrolysis configuration.

In this implementation, the system 100 can include: a feed-supply module 150 configured to ingest metered volumes of carbon dioxide gas and water (e.g., steam)—mixed at a particular ratio corresponding to a target humidity level defined for the feed mixture—for generation of the feed mixture and pass (e.g., convey, communicate) metered volumes of the feed mixture to the fuel inlet of the module housing 140 for supplying to one or more cathode layers 124 of the cell stack 120; and an air-supply module 170 configured to supply metered volumes of air—including nitrogen, oxygen, and other secondary gases (e.g., argon, carbon dioxide) to the air inlet 144 of the module housing 140 for supplying to one or more anode layers 126 of the cell stack 120.

In this implementation, the electrolysis module 102 can be configured to: receive the feed mixture—including carbon dioxide and water—from the feed-supply module 150 at the feed inlet 142 of the module housing 140; receive the air mixture—including ambient air and/or oxygen-enriched air—from the air-supply module 170; and communicate the feed mixture across the set of cathode layers 124 (or “fuel electrodes”) of the reversible fuel cell 122 stack 120—and concurrently communicate the air mixture across the set of anode layers 126 (or “oxygen electrodes”) of the reversible fuel cell 122 stack 120—to generate a fuel mixture including syngas (i.e., carbon monoxide and hydrogen) and other secondary materials (e.g., water, carbon dioxide,) via electrolysis of carbon dioxide and water present in the feed mixture flowing over the set of cathode layers 124.

The system 100 can further include a fuel-processing module 160 configured to receive the fuel mixture from the electrolysis module 102 and remove secondary materials (e.g., water, carbon dioxide) from the fuel mixture to generate a concentrated syngas mixture including carbon monoxide and hydrogen. In particular, the fuel-processing module 160 can be configured to reduce a concentration of secondary materials present in the fuel mixture received from the electrolysis module 102 to generate a final fuel mixture—including syngas (i.e., carbon monoxide and hydrogen) exhibiting a concentration exceeding a threshold concentration (e.g., 50 percent, 80 percent, 99 percent).

In one implementation, the fuel-processing module 160 can include: a water separation unit 162 (e.g., the dryer unit 162) configured to receive the fuel mixture—including a first concentration of syngas and a set of secondary materials (e.g., carbon dioxide, water,) from the fuel outlet 146 and promote separation of water from the fuel mixture to generate a second fuel mixture including a second concentration of syngas exceeding the first concentration; and/or a carbon dioxide separation unit 164 configured to receive the second fuel mixture from the water separation unit and promote separation of carbon dioxide from the second fuel mixture to generate a third fuel mixture including a third concentration of syngas exceeding the second concentration.

### 7.1 Co-Electrolysis Configuration: Feed-Supply Module

In the co-electrolysis configuration, the system 100 can include a feed-supply module 150 installed on the skid 110 and configured to supply a feed mixture to the electrolysis module 102 for generation of the fuel mixture, as described above.

The feed-supply module 150 can include a gas supply assembly 152 configured to selectively supply metered volumes of a target gas (e.g., carbon dioxide, hydrogen) to the electrolysis module 102; and a water supply assembly 154 configured to selectively supply metered volumes of water for mixing with the target gas to generate the feed mixture. In particular, the gas supply assembly 152 can include: a hydrogen supply assembly 159 configured to selectively supply metered volumes of hydrogen gas to the electrolysis module 102, such as during execution of a startup cycle and/or shutdown cycle; and a carbon dioxide supply assembly 158 configured to selectively deliver metered volumes of carbon dioxide to the electrolysis module 102.

The feed-supply module 150 in the co-electrolysis configuration can include a humidification unit 151 configured to humidify carbon dioxide flowing through the humidification unit 151 to generate the feed mixture including carbon dioxide and water. The humidification unit 151 can be configured to humidify carbon dioxide with water in order to inhibit coking of materials in the feed mixture during high-temperature processing within the electrolysis module 102. In particular, the humidification unit 151 can be configured to: receive metered volumes of carbon dioxide from the carbon dioxide supply assembly 158; received metered volumes of water from the water supply assembly 154; and generate the feed mixture—including gaseous carbon dioxide and water (e.g., steam)—via humidification of carbon dioxide with water. The fuel inlet of the module housing 140 can be configured to fluidly couple to an outlet of the humidification unit 151 and therefore receive the feed mixture from the humidification unit 151.

In one implementation, the humidification unit 151 can include a humidifier membrane defining a wet-side—fluidly coupled to the water supply assembly 154—and a dry-side fluidly coupled to the carbon dioxide supply assembly 158. In this implementation, the humidification unit 151 can be configured to: inject water—received from the water supply assembly 154 and flowing over the wet-side of the humidifier membrane—into carbon dioxide received from the carbon dioxide supply assembly 158 and flowing over the dry-side of the humidifier membrane; and output the feed mixture—including carbon dioxide and water mixed according to a target humidity level defined for the feed mixture—from an outlet of the dry-side for supplying to the electrolysis module 102.

In this implementation, the carbon dioxide supply assembly 158 can be configured to supply metered volumes of carbon dioxide to the dry-side of the humidifier membrane. For example, the carbon dioxide supply assembly 158 can include: a gas inlet duct fluidly coupled to an external carbon dioxide supply and a gas inlet of the humidification unit 151; and a mass flow controller—integrated within the gas inlet duct—configured to regulate flow of carbon dioxide into the humidification unit 151. In particular, in one example, the carbon dioxide supply assembly 158 can include an isolation valve, an electronic pressure regulator, a solenoid valve, and a mass flow controller—integrated into the carbon dioxide supply inlet—configured to cooperate to regulate flow and/or pressure of carbon dioxide received from the external carbon dioxide supply and fed to the humidification unit 151.

Additionally, the water supply assembly 154 can be configured to supply metered volumes of water (e.g., heated water) to the wet-side of the membrane humidifier. In particular, the water supply assembly 154 can include: a water tank 155 fluidly coupled to an external water supply and configured to store a volume of water; a heating element (e.g., a heater) coupled to the water tank 155 and configured to regulate temperature of water within the water tank 155 within a target water temperature range corresponding to a target humidity level of the feed mixture (e.g., output by the humidification unit 151); and a pump 157 fluidly coupled to the water tank 155 and configured to regulate flow of water and/or water pressure from the water tank 155—at temperatures within the target temperature range—through the wet-side of the humidification unit 151. The water supply assembly 154 can further include a motor mechanically coupled to the pump 157 and configured to drive the pump 157 to regulate water flow and/or pressure into the humidification unit 151.

Further, the water supply module can be configured to return excess water—released from an outlet of the wet-side of the humidification unit 151—to the water tank 155. For example, the water supply assembly 154 can include a water return (e.g., a duct) configured to communicate excess water from an outlet of the wet-side of the humidifier membrane into the water tank 155 for recycling during subsequent humidification cycles.

In this implementation, the water tank 155 of the water supply assembly 154 can be fluidly coupled to an external water supply for replenishing the volume of water in the water tank 155. For example, the water supply assembly 154 can include: a water inlet duct fluidly coupled to an external water supply (e.g., external the skid 110) and the water tank 155 and configured to supply metered volumes of water to the water tank 155; a water filter and/or water deionizer integrated within the water inlet duct; and/or a set of valves (e.g., an isolation valve) configured to regulate water flow and/or pressure of water into the water tank 155, as described above. Further, the water tank 155 can be fluidly coupled to a water outlet of the dryer unit 162 of the fuel-processing module 160, such that the water tank 155 can receive water—removed from the fuel mixture by the dryer unit 162—from the water outlet of the dryer unit 162.

Additionally, the water tank 155 can include a drain outlet—including a valve integrated into the outlet—configured to selectively convey water from the water tank 155 and into the external water supply in order to maintain a target volume of water within the water tank 155.

### 7.2 Operation: Co-Electrolysis

In one implementation, as described above, the system 100 can be configured to generate syngas—including carbon monoxide and hydrogen—via electrolysis of carbon dioxide and water in a co-electrolysis configuration.

In particular, in this implementation, the system 100 can: ingest a volume of carbon dioxide (e.g., supplied from an external carbon dioxide source); humidify this volume of carbon dioxide to generate a feed mixture of carbon dioxide and water (e.g., steam); and communicate this feed mixture to the electrolysis module 102 (e.g., via the cathode inlet of the module housing 140) within the electrolysis module 102. Then, at the electrolysis module 102, the system 100 can: heat the feed mixture to a temperature within a target feed temperature range, such as via a set of heat exchangers 134 and/or via heat transfer from hot, gaseous streams exiting the cell stack 120; draw the feed mixture over a cathode of a reversible fuel cell 122 within the cell stack 120 and concurrently draw a stream of air—including oxygen—over an anode of the fuel cell; and thereby generate a fuel mixture—including syngas (i.e., carbon monoxide and hydrogen) and a set of secondary materials including carbon dioxide and/or water (e.g., excess carbon dioxide and/or water)—at an outlet of the cathode and an oxygen-enriched air mixture at an outlet of the anode. The system 100 can then: release the fuel mixture from the electrolysis module 102 and through a dryer unit 162 configured to extract water present in the fuel mixture to increase a concentration of syngas (i.e., carbon dioxide and hydrogen) in the fuel mixture; convey the fuel mixture from an outlet of the dryer unit 162 through a separation unit 164 (e.g., an carbon dioxide adsorber, a high-pressure separation unit) configured to remove carbon dioxide from the fuel mixture to further increase the concentration of syngas in the fuel mixture; and collect the fuel mixture—including a concentration of syngas exceeding a threshold concentration (e.g., 50 percent, 75 percent, 95 percent)—at an outlet of the separation unit 164 for storage.

### 8. Water Electrolysis Configuration

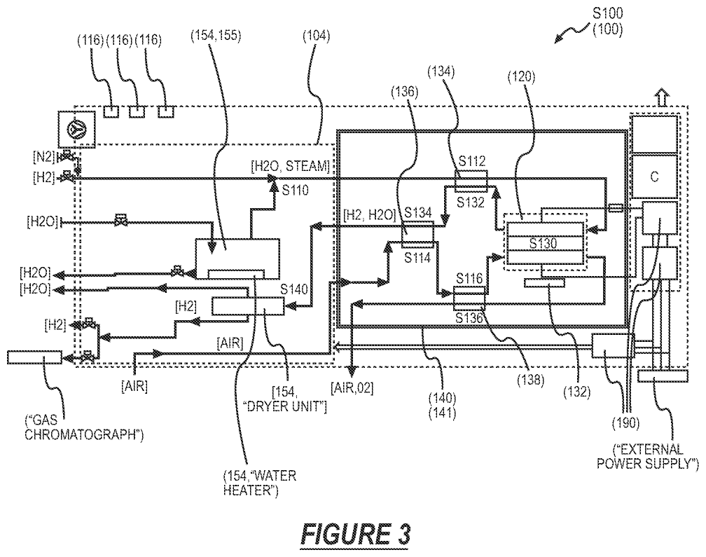

In one implementation, as shown in FIG. 3, the system 100 can be configured to convert metered volumes of a feed mixture including water (e.g., steam) into volumes of a fuel mixture including hydrogen gas via electrolysis of water in a water electrolysis configuration.

In this implementation, the system 100 can include: a feed-supply module 150 configured to supply metered volumes of water (e.g., steam) to the feed inlet 142 of the module housing 140 for supplying to one or more cathode layers 124 of the cell stack 120; and an air-supply module 170 configured to supply metered volumes of air—including nitrogen, oxygen, and other secondary gases (e.g., argon, carbon dioxide)—to the air inlet 144 of the module housing 140 for supplying to one or more anode layers 126 of the cell stack 120.

In this implementation, the electrolysis module 102 can be configured to: receive the feed mixture—including gaseous water (or “steam”)—from the feed-supply module 150 at the feed inlet 142 of the module housing 140; receive the air mixture—including ambient air and/or oxygen-enriched air—from the air-supply module 170; and communicate the feed mixture across the set of cathode layers 124 (or “fuel electrodes”) of the reversible fuel cell stack 120—and concurrently communicate the air mixture across the set of anode layers 126 (or “oxygen electrodes”) of the reversible fuel cell stack 120—to generate a fuel mixture including hydrogen and other secondary materials (e.g., water, oxygen) via electrolysis of water present in the feed mixture flowing over the set of cathode layers 124.

The system 100 can further include a fuel-processing module 160 configured to receive the fuel mixture from the electrolysis module 102 and remove secondary materials (e.g., excess water) from the fuel mixture to generate a concentrated hydrogen mixture. In particular, the fuel-processing module 160 can be configured to reduce a concentration of secondary materials present in the fuel mixture received from the electrolysis module 102 to generate a final fuel mixture including hydrogen (e.g., hydrogen gas) and exhibiting a hydrogen concentration exceeding a threshold concentration. In particular, in one implementation, the fuel-processing module 160 can include a dryer unit 162 configured to receive the fuel mixture—including a first concentration of hydrogen and a set of secondary materials (e.g., water)—from the fuel outlet 146 and promote separation of water from the fuel mixture to generate a second fuel mixture including a second concentration of hydrogen exceeding the first concentration.

### 8.1 Water Electrolysis Configuration: Feed-Supply Module

In the preceding implementation, the feed-supply module 150 can include: a hydrogen supply assembly 159 configured to selectively supply metered volumes of hydrogen to the electrolysis module 102, such as during a startup cycle for the system 100; and a water supply assembly 154 configured to selectively supply metered volumes of water (e.g., steam) to the electrolysis module 102 (e.g., during an active electrolysis period), such as during an electrolysis cycle succeeding the startup cycle for the system 100.

The water supply assembly 154 can include: a water tank 155 fluidly coupled to an external water supply; a water inlet duct fluidly coupled to the external water supply and configured to supply metered volumes of water to the water tank 155; a water filter and/or water deionizer integrated within the water inlet duct; and/or a set of valves (e.g., an isolation valve) configured to regulate water flow and/or pressure of water into the water tank 155.

In one implementation, the water supply assembly 154 can be configured to communicate metered volumes of steam (i.e., gaseous water) from the water tank 155 to the feed inlet 142 of the module housing 140. In this implementation, the water supply assembly 154 can include: a water tank 155 fluidly coupled to an external water supply and defining an exhaust outlet; a heater coupled to the water tank 155 and configured to regulate a water temperature of water in the water tank 155 within a target water temperature range configured to generate steam from water in the water tank 155; and a flow meter—in combination with a flow control valve—fluidly coupled to the exhaust outlet and configured to supply metered volumes of steam from the water tank 155 to the feed inlet 142 of the module housing 140. The feed inlet 142 of the module housing 140 can therefore receive metered volumes of steam from the exhaust outlet of the water tank 155.

In particular, in this implementation, the water supply assembly 154 can include: the water tank 155 configured to store a volume of liquid water within a lower portion of the water tank 155 and include a steam outlet arranged within an upper portion of the water tank 155 (e.g., above a liquid water level) above the lower portion; and the heater coupled to the water tank 155 and configured to heat liquid water present in the tank to temperatures within a target temperature range to convert volumes of water into steam within the water tank 155. The water supply assembly 154 can then be configured to direct metered volumes of steam—released from the water tank 155 via the steam outlet—toward the feed inlet 142 of the module housing 140 for passing to the cathode layer 124 of the cell stack 120. For example, the water supply assembly 154 can include: an exhaust duct fluidly coupled to the exhaust outlet and the feed inlet 142 of the module housing 140; and a flow control valve and/or flow meter coupled to the exhaust duct and configured to regulate a flow rate of steam released into the feed inlet 142 of the module housing 140.

Alternatively, in another implementation, the water supply assembly 154 can be configured to: communicate metered volumes of liquid water from a buffer tank 156 for heating in-line via a water heater to generate steam (i.e., gaseous water); and communicate metered volumes of steam from the water heater to the feed inlet 142 of the module housing 140. In particular, in this implementation, the water supply assembly 154 can include: a buffer tank 156 fluidly coupled to an external water supply and configured to transiently store volumes of water; a fluid duct fluidly coupled to the buffer tank 156 and the feed inlet 142 of the module housing 140; and a water heater fluidly coupled to the fluid duct and configured to heat metered volumes of water received from the buffer tank 156 to generate metered volumes of steam in the fluid duct. The feed inlet 142 can therefore receive metered volumes of steam from the fluid duct. For example, the water heater (an in-line water heater) can be configured to: receive a metered volume of liquid water from the buffer tank 156; and heat this metered volume of liquid water to a temperature within a target temperature range (e.g., exceeding 100 degrees Celsius) to transform this volume of liquid water into steam (i.e., gaseous water).

Further, in the preceding implementation, the water supply assembly 154 can include: a water tank 155—configured to store a volume of water—fluidly coupled to the dryer unit 162 of the fuel-processing module 160, such that the water tank 155 can receive water output by the electrolysis module 102 and removed from the fuel mixture by the dryer unit 162; and a pump 157 (e.g., a reciprocating pump) fluidly coupled to the water tank 155 and configured to transport metered volumes of water (e.g., liquid water) from the water tank 155 to the buffer tank 156.

### 8.2 Operation: Water Electrolysis

In one implementation, as described above, the system 100 can be configured to generate hydrogen gas via electrolysis of water in a water electrolysis configuration.

In particular, in this implementation, the system 100 can: supply a feed mixture—including water (e.g., steam)—at a particular rate, temperature, and/or pressure to the electrolysis module 102 (e.g., via the feed inlet 142 of the module housing 140). Then, at the electrolysis module 102, the system 100 can: heat the feed mixture to a temperature within a target feed temperature range, such as via a set of heat exchangers 134 and/or via heat transfer from hot, gaseous streams exiting the cell stack 120; draw the feed mixture over a cathode layer 124 (or “cathode”) of a reversible fuel cell 122 within the cell stack 120 and concurrently draw a stream of air—including oxygen—over an anode layer 126 (or “anode”) of the reversible fuel cell 122; and thereby generate a fuel mixture—including hydrogen (e.g., hydrogen gas) and a set of secondary materials (e.g., water)—at an outlet of the cathode layer 124 and an oxygen-enriched air mixture at an outlet of the anode layer 126. The system 100 can then release the fuel mixture from the electrolysis module 102 and through a dryer unit 162 configured to extract water present in the fuel mixture; and collect the fuel mixture—including a concentration of hydrogen exceeding a threshold concentration (e.g., 50 percent, 75 percent, 95 percent)—at an outlet of the dryer unit 162. The system 100 can then convey volumes of water—extracted from the fuel mixture in the dryer unit 162—to the water supply assembly 154 and/or to the water tank 155 (e.g., via a water return) for recycling in subsequent electrolysis cycles. Alternatively, the system 100 can collect water extracted from the fuel mixture in the dryer unit 162 for storage (e.g., external the skid no).

### 9. Carbon Dioxide Electrolysis Configuration

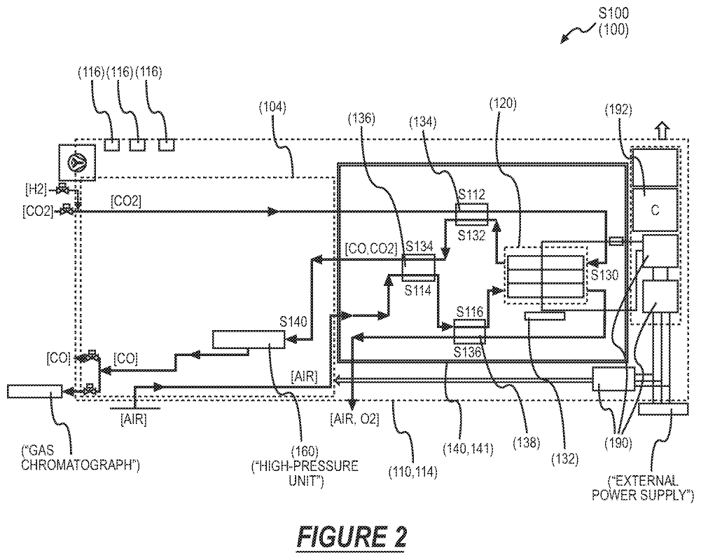

In one implementation, as shown in FIG. 2 the system 100 can be configured to convert metered volumes of a feed mixture including carbon dioxide (e.g., CO₂) into volumes of a fuel mixture including carbon monoxide gas via electrolysis of carbon dioxide in a carbon dioxide electrolysis configuration.

In this implementation, the system 100 can include: a feed-supply module 150 configured to supply metered volumes of carbon dioxide (e.g., CO₂ gas) to the feed inlet 142 of the module housing 140 for supplying to one or more cathode layers 124 of the cell stack 120; and an air-supply module 170 configured to supply metered volumes of air—including nitrogen, oxygen, and other secondary gases (e.g., argon, carbon dioxide)—to the air inlet 144 of the module housing 140 for supplying to one or more anode layers 126 of the cell stack 120.

In this implementation, the electrolysis module 102 can be configured to: receive the feed mixture—including carbon dioxide (or “CO₂”)—from the feed-supply module 150 at the feed inlet 142 of the module housing 140; receive the air mixture—including ambient air and/or oxygen-enriched air—from the air-supply module 170 at the air inlet 144 of the module housing 140; and communicate the feed mixture across the set of cathode layers 124 (or “fuel electrodes”) of the reversible fuel cell stack 120—and concurrently communicate the air mixture across the set of anode layers 126 (or “oxygen electrodes”) of the reversible fuel cell stack 120—to generate a fuel mixture including carbon monoxide and other secondary materials (e.g., carbon dioxide) via electrolysis of carbon dioxide present in the feed mixture flowing over the set of cathode layers 124.

The system 100 can further include a fuel-processing module 160 configured to receive the fuel mixture from the electrolysis module 102 and remove secondary materials (e.g., carbon dioxide) from the fuel mixture to generate a concentrated carbon monoxide mixture. In particular, the fuel-processing module 160 can be configured to reduce a concentration of secondary materials present in the fuel mixture received from the electrolysis module 102 to generate a final fuel mixture including carbon monoxide and exhibiting a carbon monoxide concentration exceeding a threshold concentration.

### 9.1 Carbon Dioxide Electrolysis Configuration: Feed-Supply Module+Fuel-Processing Module

In the preceding implementation, the feed supply module 150 can include: a hydrogen supply assembly 159 configured to selectively supply metered volumes of hydrogen to the electrolysis module 102, such as during a startup cycle for the system 100; and a carbon dioxide supply assembly 158 configured to selectively supply metered volumes of carbon dioxide to the electrolysis module 102 (e.g., during an active electrolysis period) for generation of carbon monoxide, such as during an electrolysis cycle succeeding the startup cycle for the system 100.

Furthermore, in this implementation, the fuel-processing module 160 can include a separation unit 164 (e.g., a high-pressure unit) configured to: receive the fuel mixture—including a first concentration of carbon monoxide and a set of secondary materials (e.g., carbon dioxide)—from the fuel outlet 146; and promote separation of carbon dioxide from the fuel mixture via pressure swing adsorption to generate a second fuel mixture including a second concentration of carbon monoxide exceeding the first concentration.

For example, the fuel-processing module 160 can include a high-pressure unit including an absorbent layer (e.g., a zeolite layer, a silica gel layer, a resin layer)—configured to adsorb carbon dioxide. In this example, the high-pressure unit can be configured to: receive a first fuel mixture—including a first concentration of carbon monoxide mixed with carbon dioxide—from the fuel outlet 146 of the module housing 140; pressurize the fuel mixture—from pressures within a first pressure range to pressures within a second pressure range exceeding the first pressure range—to promote adsorption of carbon dioxide from the fuel mixture into the absorbent layer; and output a second fuel mixture including a second concentration of carbon monoxide exceeding the first concentration.

Furthermore, in one variation, the fuel processing module 160 can include a carbon dioxide return outlet configured to collect carbon dioxide—extracted from the fuel mixture in the separation unit 164—for recycling to the carbon dioxide supply assembly 158.

### 9.2 Operation: Carbon Dioxide Electrolysis

In one implementation, as described above, the system 100 can be configured to generate carbon monoxide gas via electrolysis of carbon dioxide in a carbon dioxide electrolysis configuration.

In particular, in this implementation, the system 100 can: supply (e.g., convey, transport, feed) a feed mixture including carbon dioxide—such as via selective actuation of a series of valves, flow controllers, pressure regulators, etc. —at a particular rate, temperature, and/or pressure to the electrolysis module 102 (e.g., via the feed inlet 142). Then, at the electrolysis module 102, the system 100 can: heat the feed mixture to a temperature within a target feed temperature range, such as via a set of heat exchangers 134 and/or via heat transfer from hot, gaseous streams exiting the cell stack 120; draw the feed mixture over a cathode layer 124 (or “cathode”) of a reversible fuel cell 122 within the cell stack 120 and concurrently draw a stream of air—including oxygen—over an anode layer 126 (or “anode”) of the reversible fuel cell 122; and thereby generate a fuel mixture—including carbon monoxide (e.g., carbon monoxide gas) and a set of secondary materials (e.g., carbon dioxide)—at an outlet of the cathode layer 124 and an oxygen-enriched air mixture at an outlet of the anode layer 126. The system 100 can then: release (e.g., convey, pass) the fuel mixture from the electrolysis module 102 and through a separation unit 164 (e.g., a high-pressure separation unit) configured to extract carbon dioxide present in the fuel mixture to increase a concentration of carbon monoxide in the fuel mixture; and collect the fuel mixture—including a concentration of carbon monoxide exceeding a threshold concentration (e.g., 50 percent, 75 percent, 95 percent)—at an outlet of the separation unit 164 for storage.

### 10. Controls

The system 100 and/or controller 192 can be configured to track and regulate a set of operating controls—representing operation of the electrolysis module 102, the balance of plant module, and/or the power module 190—to promote high-efficiency and/or high-capacity operation of the reversible fuel cell 122 stack 120 within the electrolysis module 102.

For example, the controller 192 can selectively regulate: a current applied across the cell stack 120; and a temperature and/or temperature gradient of the cell stack 120. In particular, in this implementation, the controller 192 can: selectively trigger distribution of power from the power module 190 to the cell stack 120 to regulate the current applied across the cell stack 120 within a target current range defined for the cell stack 120; and/or selectively trigger distribution of power from the power module 190 to the stack heater 132—coupled to the cell stack 120—to regulate the temperature of the cell stack 120 within a target temperature range defined for the cell stack 120.

Additionally or alternatively, in another example, the controller 192 can selectively regulate a temperature of fluid circulating the electrolysis module 102, such as including a temperature of the feed mixture, a temperature of the air mixture, a temperature of the fuel mixture, and/or a temperature of the oxygen mixture. In particular, in this implementation, the controller 192 can selectively trigger distribution of power from the power module 190 to the set of stack heaters 132—such as including the stack heater 132, the feed heat exchanger, the air heat exchanger 137, and/or the fuel-air heat exchanger 138—to regulate the temperature of the cell stack 120 within a target temperature range defined for the cell stack 120.

Additionally or alternatively, in another example, the controller 192 can selectively regulate: flow rates of fluid into the electrolysis module 102—and therefore into the reversible fuel cell 122 stack 120—such as including a flow rate of the feed mixture into the feed inlet 142 of the module housing 140 and/or a flow rate of the air mixture into the air inlet 144 of the module housing 140; and/or flow rates of fluids circulating the balance of plant module, such as including a flowrate of carbon dioxide and/or water fed to the humidification unit 151 in the co-electrolysis configuration.

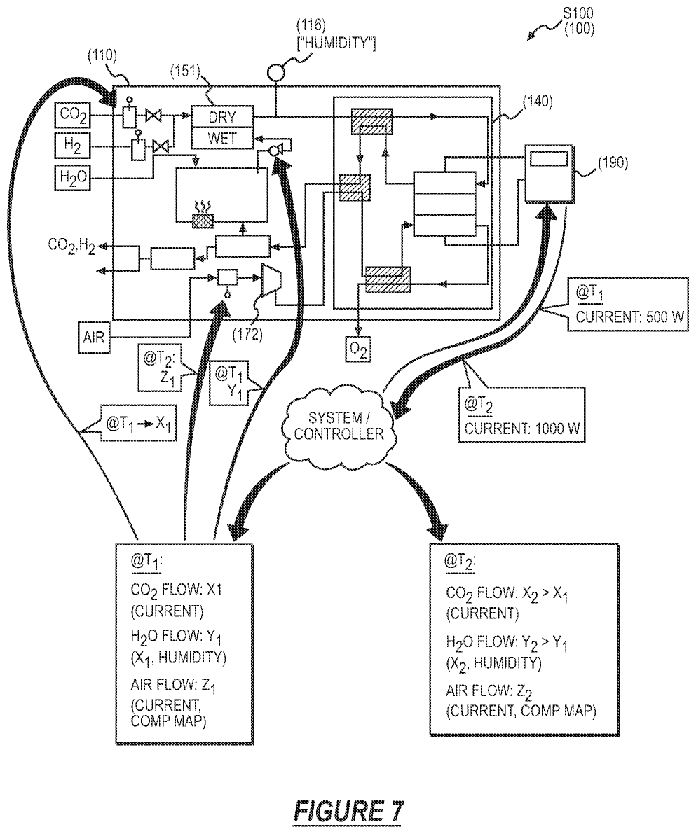

In each of these examples, the controller 192 can be configured to concurrently regulate each of these operating controls in order to promote electrolysis within the cell stack 120, such as at a target efficiency and/or target capacity. In one implementation, the controller 192 can be configured to regulate the set of operating controls based on a current applied to the cell stack 120. For example, as shown in FIG. 7, the controller 192 can: distribute power from a power supply to a heating element coupled to the cell stack 120 to regulate a temperature of the cell stack 120 within a target stack temperature range configured to promote electrolysis of the feed mixture; selectively distribute power from a power supply to the cell stack 120 to regulate a current applied across the cell stack 120 within a target current range configured to promote electrolysis of the feed mixture; regulate a gas flow rate of the gaseous mixture into the humidification unit 151 and through the cathode layer 124 based on the current, such as configured to achieve a target cell stack 120 efficiency; and regulate a water temperature of water flowing into the humidification unit 151 based on the gas flow rate and a target humidity level—corresponding to the target cell stack 120 efficiency—defined for the feed mixture.

### 11. Operating Protocols

Generally, the system 100 can be configured to transition between a deactivated state (or “off” state)—in which the power module 190 is electrically decoupled from an external power supply—and an active state (or “on” state) in which the power module 190 is electrically coupled and receives power from the external power supply.

In the active state, the system 100 can execute a series of operating protocols—each operating protocol defining a set of target controls—configured to maximize efficiency of electrolysis and limit risk associated with operation of the system 100. In particular, the system 100 can repeat this series of operating protocols during each live period, in a series of live periods, corresponding to the system 100 in the active state.

For example, in response to activation of the power module 190, the system 100 and/or controller 192 can: execute a start-up protocol—defining a first set of target controls for the electrolysis module 102—configured to prepare an environment of the cell stack 120, within the module housing 140, for electrolysis of the feed mixture; in response to completion of the start-up protocol, execute an electrolysis protocol—defining a second set of target controls for the balance of plant module 104 and the electrolysis module 102—configured to regulate electrolysis of the feed mixture; and, in response to termination of the electrolysis protocol; and, in response to completion of the electrolysis protocol—such as via manual termination by an operator and/or automatic termination based on efficiency of the cell stack 120—execute a shut-down protocol defining a third set of target controls and configured to transition the system 100 from the active state to the inactive state.

### 11.1 Start-Up Protocol

The system 100 can execute a start-up protocol (e.g., during a startup period) configured to prepare an environment of the cell stack 120—installed (e.g., transiently, semi-permanently, permanently) within the module housing 140—for electrolysis of the feed mixture. In particular, the system 100 can automatically initiate the start-up protocol in response to a transition of the power module 190 from the inactive state to the active state.

In one implementation, the system 100 and/or controller 192 can sequentially verify that a set of start-up controls—associated with operation of the electrolysis module 102—correspond to (e.g., match, fall within a threshold deviation) a set of target start-up controls defined by the start-up protocol. For example, the system 100—and/or the controller 192—can execute a start-up protocol defining: a self-check cycle defining a set of self-check controls; an authorization cycle defining a set of authorization controls; a pre-charge cycle defining a set of pre-charge controls; a purge cycle defining a set of purge controls; and a heating cycle defining a set of heating controls.

In particular, in one example, during a start-up period preceding a fuel generation period, the system 100 can: execute a fault analysis to verify each self-check control, in a set of self-check controls, falling within a target range defined for the self-check control during a self-check cycle. For example, the system 100 can access a set of sensors installed within the skid 110 to verify: a hydrogen level falls within a target hydrogen level range; and a smoke level falls within a target smoke level range. In this example, in response to the hydrogen level falling outside of the target hydrogen range and/or the smoke level falling outside of the target smoke level range, the system 100 can automatically terminate the start-up protocol and/or alert an operator to investigate. Alternatively, in response to each self-check control, in the set of self-check controls, falling within the corresponding target range, the system 100 can: trigger actuation of a ventilation fan within the skid housing; and verify completion of the self-check cycle.

Then, during an authorization cycle succeeding the self-check cycle, in response to verifying completion of the self-check cycle, the system 100 can prompt an operator to authorize execution of the startup protocol. Then, during a pre-charge cycle succeeding the authorization cycle, in response to receiving authorization from the operator, the system 100 can distribute power from the power module to the stack heater to verify operation of the power module and the stack heater. Then, during a purge cycle of a target duration (e.g., 5 seconds, 15 seconds, 1 minute, 5 minutes), in response to verifying operation of the power module and the stack heater, the system 100 can: convey a stream of hydrogen from the hydrogen supply assembly 159 across the cathode layer; and convey a stream of the air mixture from the air-supply module across the anode layer to purge the cathode and anode layers.

Finally, during a conditioning cycle (e.g., succeeding the purge cycle), in response to expiration of the target duration, the system 100 can: convey the stream of hydrogen from the hydrogen supply across the cathode layer to generate a reducing environment at the cathode layer; subject the cell stack to thermal conditioning by regulating a stack temperature of the cell stack from a first stack temperature (e.g., room temperature) to a second stack temperature (e.g., 850 degrees Celsius), within a target stack temperature range, according to a target temperature ramp rate (e.g., 1.5 degrees Celsius-performance-minute), via a heating element coupled to the cell stack; and, in response to the stack temperature falling within the target stack temperature range, verify completion of the start-up protocol and therefore terminate the conditioning cycle and initiate an electrolysis cycle during a fuel generation period succeeding the startup period.

### 11.2 Electrolysis Protocol

As described above, the system 100 can execute an electrolysis protocol in response to verifying completion of the start-up cycle. In one implementation, the system 100 can track and regulate a set of operating controls. In particular, the system 100 can regulate the set of operating controls in order to maximize efficiency and/or longevity (e.g., a shelf life) of the cell stack and/or other components of the system 100.

For example, during an initial period of the electrolysis cycle, the system 100 can incrementally increase a current applied across the cell stack by the power module up to a target current (e.g., 1000 W). During this initial period, the system 100 can further regulate a flow rate of carbon dioxide from the feed supply module to the electrolysis module based on the current applied to the cell stack. For example, at a first time during the initial period of the electrolysis cycle, the system 100 and/or controller can apply a first current (e.g., 500 W) across the cell stack and thus regulate a carbon dioxide flow rate within a first range, such as at a relatively low flowrate. Then, at a second time during the initial period of the electrolysis cycle, succeeding the first time, the system 100 and/or controller can apply a second current (e.g., 1000 W) across the cell stack—exceeding the first current—and thus regulate the carbon dioxide flow rate within a second range exceeding the first range, such as at a relatively high flowrate.

The system 100 can similarly: regulate a flowrate of water through the humidification unit 151 (e.g., in the co-electrolysis configuration) based on the carbon dioxide flow rate and a target humidity level defined for the cell stack, such as configured to promote electrolysis of the feed mixture; regulate an air flowrate of air from the air-supply module to the electrolysis module based on the current applied to the cell stack and/or a compressor map defined for the compressor 172; regulate a stack temperature of the cell stack within a target temperature range defined for the cell stack and configured to promote electrolysis of the feed mixture; and/or regulate a dryer temperature of the dryer unit 162 to within a temperature range corresponding to a subzero dew point of hydrogen output by the electrolysis module. The system 100 can therefore concurrently track and/or regulate each of these operating controls throughout a duration of the electrolysis cycle.

### 11.3 Shutdown Protocol

In response to completion of the electrolysis protocol—such as due to manual and/or automated termination—the system 100 can execute a shutdown protocol.

In one implementation, the system 100 and/or controller 192 can sequentially verify that a set of shutdown controls correspond to (e.g., match, fall within a threshold deviation) a set of target shutdown controls defined by the shutdown protocol. For example, the system 100—and/or the controller 192—can execute a shutdown protocol defining: load-reduction cycle defining a set of load-reduction controls; a cooling cycle defining a set of cooling controls; and an isolation cycle defining a set of isolation controls.

In particular, in one example, during a shutdown period succeeding a fuel generation period, the system 100 can execute a load-reduction cycle by: incrementally decreasing the current applied across the cell stack to a target current (e.g., 0 Watts); regulate the carbon dioxide flowrate from the feed supply module to the electrolysis module based on the current applied to the cell stack to reduce the flow rate; regulate a flowrate of water through the humidification unit 151 based on the carbon dioxide flow rate and the target humidity level defined for the cell stack, such as configured to promote electrolysis of the feed mixture; regulate an air flowrate of air from the air-supply module to the electrolysis module based on the current applied to the cell stack and/or the compressor map defined for the compressor 172; regulate the stack temperature of the cell stack within a target temperature range defined for the cell stack and configured to promote electrolysis of the feed mixture; and/or regulate the dryer temperature of the dryer unit 162 to within a temperature range corresponding to a subzero dew point of hydrogen output by the electrolysis module.

Then, during a cooling cycle, in response to verifying completion of the load-reduction cycle—such as in response to the current applied across the cell stack matching the target current—the system 100 can: convey hydrogen from the hydrogen supply assembly 159 across the cathode layer to generate a reducing environment at the cathode layer; and subject the cell stack to thermal conditioning by regulating the stack temperature of the cell stack from a first stack temperature (e.g., 850 degrees Celsius) to a second stack temperature (e.g., 25 degrees Celsius), within a target stack temperature range defined for the cooling cycle, according to a target temperature ramp rate (e.g., −1.5 degrees Celsius-performance-minute); and, in response to the stack temperature falling within the target stack temperature range, verify completion of the cooling cycle.

Finally, during an isolation cycle succeeding the cooling cycle, in response to verifying completion of the cooling cycle, the system 100 can: terminate flow of hydrogen through the electrolysis module; terminate operation of components of the balance-of-plant and/or electrolysis modules (e.g., air compressors, blowers); terminate supply of power from the power module to the cell stack; and therefore verify completion of the isolation cycle and the shutdown protocol.

### 11.4 Failure Detection & Recovery

In one implementation, the controller 192 can detect instances of non-compliant operation and selectively implement a recovery protocol accordingly.

In particular, the controller 192 can: interpret a set of operating conditions within an instance of the system 100 based on signals output by the set of sensors 116 installed (e.g., transiently, semi-permanently, and/or permanently installed) on the skid 110; interpret an instance of non-compliant operation—such as an overheated cell stack 120, presence of smoke within the skid housing 114, cell efficiency falling below a threshold efficiency, etc.—based on the set of operating conditions; select a recovery protocol—such as reducing power supply to the stack heater 132, executing an emergency shutdown protocol, scheduling execution of a shutdown protocol for replacement of the current electrolysis module 102 with a new electrolysis module 102, etc. —from a set of recovery protocols corresponding to the instance of non-compliant operation; and trigger execution of the recovery protocol accordingly.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other system 100s and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a humidification cycle at a humidification unit, humidifying a gaseous mixture comprising carbon dioxide with a volume of water to generate a feed mixture comprising carbon dioxide and water;
during a heating cycle, conveying the feed mixture, from the humidification unit, across a first side of a first heat exchanger to heat the feed mixture from a first feed temperature at a first heat exchanger inlet to a second feed temperature, within a target feed temperature range, at a first heat exchanger outlet, the second feed temperature exceeding the first feed temperature;
during an electrolysis cycle:
conveying an air mixture comprising oxygen through an anode layer of a reversible fuel cell, in a set of reversible fuel cells, in a cell stack; and
conveying the feed mixture from the first heat exchanger outlet across a cathode layer of the reversible fuel cell to generate a first fuel mixture at the cathode layer via electrolysis of the feed mixture, the first fuel mixture comprising syngas and a first concentration of secondary materials comprising water and oxygen; and
during a cooling cycle, conveying the first fuel mixture from the cell stack over a second side of the first heat exchanger to cool the first fuel mixture from a first fuel temperature at a second heat exchanger inlet to a second fuel temperature at a second heat exchanger outlet, the second fuel temperature falling below the first fuel temperature; and
during a purification cycle:
conveying the first fuel mixture from the second heat exchanger outlet through a dryer unit configured to reduce a dew point of syngas in the first fuel mixture and promote separation of water from the fuel mixture, to generate a second fuel mixture comprising syngas and a second concentration of secondary materials comprising oxygen, the second concentration less than the first concentration;
conveying the second fuel mixture through a separator unit configured to extract oxygen from the second fuel mixture to generate a third fuel mixture comprising a concentration of syngas exceeding a threshold concentration; and
collecting the third fuel mixture at a separator outlet of the separator unit.

2. The method of claim 1:
further comprising, during the heating cycle, conveying the air mixture from an air supply over a first side of a second heat exchanger to heat the air mixture from a first air temperature at a third heat exchanger inlet to a second air temperature at a third heat exchanger outlet within a target air temperature range, the second air temperature exceeding the first air temperature;
wherein conveying the air mixture through the anode layer comprises conveying the air mixture from the third heat exchanger outlet through the anode layer; and
further comprising, during the cooling cycle, conveying the air mixture from the cell stack over a second side of the second heat exchanger to cool the air mixture from a third air temperature at a fourth heat exchanger inlet to a fourth air temperature at a fourth heat exchanger outlet, the fourth air temperature falling below the third air temperature.

3. The method of claim 2:
further comprising, during the cooling cycle:
conveying the first fuel mixture from the second heat exchanger outlet over a first side of a second heat exchanger to cool the first fuel mixture from the second fuel temperature at a third heat exchanger inlet to a third fuel temperature at a third heat exchanger outlet, the third fuel temperature falling below the second fuel temperature; and
conveying the air mixture from an air supply over a second side of the second heat exchanger to heat the air mixture from a first air temperature at a fourth heat exchanger inlet to a second air temperature at a fourth heat exchanger outlet within a target air temperature range, the second air temperature exceeding the first air temperature;
wherein conveying the air mixture through the anode layer comprises conveying the air mixture from the fourth heat exchanger outlet through the anode layer; and
wherein conveying the first fuel mixture from the second heat exchanger outlet through the dryer unit comprises conveying the first fuel mixture from the third heat exchanger outlet through the dryer unit.

4. The method of claim 1:
wherein humidifying the gaseous mixture at the humidification unit comprises humidifying the gaseous mixture at the humidification unit during a fuel generation period comprising the humidification period, the heating period, the electrolysis period, the cooling period, and the purification period, and the fuel generation period; and
further comprising, during a startup period preceding the fuel generation period:
during a purge cycle of a target duration, conveying a stream of hydrogen from a hydrogen supply across the cathode layer and conveying a stream of the air mixture across the anode layer; and
in response to expiration of the target duration, during a conditioning cycle succeeding the purge cycle:
conveying the stream of hydrogen from the hydrogen supply across the cathode layer to generate a reducing environment at the cathode layer;
subjecting the cell stack to thermal conditioning by regulating a stack temperature of the cell stack from a first stack temperature to a second stack temperature, within a target stack temperature range, according to a temperature ramp rate via a heating element coupled to the cell stack; and
in response to the stack temperature falling within the target stack temperature range, terminating the conditioning cycle.

5. The method of claim 4, further comprising, during a shutdown period succeeding the fuel generation period:
conveying the stream of hydrogen from the hydrogen supply across the cathode layer to generate the reducing environment at the cathode layer; and
subjecting the cell stack to thermal conditioning by regulating the stack temperature from a third stack temperature, within the target stack temperature range, to a fourth stack temperature according to the temperature ramp rate via the heating element coupled to the cell stack.

6. The method of claim 1 further comprising, during a fuel generation period comprising the humidification period, the heating period, the electrolysis period, the cooling period, and the purification period:
selectively distributing power from a power supply to a heating element coupled to the cell stack to regulate a temperature of the cell stack within a target stack temperature range configured to promote electrolysis of the feed mixture;
selectively distributing power from a power supply to the cell stack to regulate a current applied across the cell stack within a target current range configured to promote electrolysis of the feed mixture;
regulating a gas flow rate of the gaseous mixture into the humidification unit and through the cathode layer based on the current; and
regulating a water temperature of water flowing into the humidification unit based on the gas flow rate and a target humidity level defined for the feed mixture.

7. The method of claim 1:
wherein conveying the air mixture comprising oxygen through the anode layer of the reversible fuel cell comprises:
ingesting air from an air supply for extraction of the air mixture comprising a first concentration of oxygen;
conveying the air mixture across a first side of a second heat exchanger to heat the air mixture from a first air temperature at a third heat exchanger inlet to a second air temperature, within a target air temperature range, at a third heat exchanger outlet, the second air temperature exceeding the first air temperature; and
conveying the air mixture from the third heat exchanger outlet across the anode layer to generate an oxygen mixture comprising a second concentration of oxygen exceeding the first concentration; and
further comprising:
conveying the oxygen mixture from the anode layer across a second side of the second heat exchanger to cool the oxygen mixture from a first oxygen temperature at a fourth heat exchanger inlet to a second oxygen temperature at a fourth heat exchanger outlet, the second oxygen temperature falling below the first oxygen temperature; and
conveying the oxygen mixture from the fourth heat exchanger outlet to a supply inlet of the air supply.

8. The method of claim 1, wherein humidifying the gaseous mixture comprising carbon dioxide with the volume of water to generate the feed mixture comprises, during a humidification cycle:
conveying the gaseous mixture from a gas supply across a dry side of a membrane at a first feed flow rate; and
conveying the volume of water from a water supply across the wet side of the membrane to generate the feed mixture via injection of steam across the membrane and into the gaseous mixture, the volume of water heated to a first temperature corresponding to the first feed flow rate and a target humidity level defined for the feed mixture.

9. The method of claim 1:
wherein humidifying the gaseous mixture with the volume of water to generate the feed mixture comprises:
conveying a stream of water from a tank outlet of the water tank through a wet side of a membrane humidifier; and
conveying the gaseous mixture across a dry side of the membrane humidifier to inject a volume of water, extracted from the stream of water flowing through the wet side, into the gaseous mixture to generate the feed mixture;
wherein conveying the first fuel mixture from the second heat exchanger outlet through the dryer unit configured to reduce the dew point of hydrogen in the first fuel mixture and promote separation of water from the first fuel mixture to generate the second fuel mixture comprises conveying the first fuel mixture from the second heat exchanger outlet through the dryer unit configured to reduce the dew point of syngas in the first fuel mixture and promote separation of water from the first fuel mixture to generate the second fuel mixture and a second volume of water;
wherein conveying the second fuel mixture from the dryer unit through the separator unit comprises conveying the second fuel mixture from a first dryer outlet of the dryer unit through the separator unit; and
further comprising, conveying the second volume of water from a second outlet of the separator unit into the water tank.

10. The method of claim 1:
further comprising, during a fuel generation period comprising the humidification period, the heating period, the electrolysis period, the cooling period, and the purification period:
selectively distributing power from a power module to the cathode and the anode to regulate a current across the reversible fuel cell within a target current range; and
selectively distributing power from the power module to a heater coupled to the cell stack to regulate a stack temperature of the cell stack within a target temperature range;
wherein humidifying the gaseous mixture to generate the feed mixture further comprises:
regulating a gas flowrate of the gaseous mixture into the humidification unit based on the current; and
regulating a temperature of water supplied to the humidification unit based on the gas flowrate and a target humidity defined for the feed mixture;
wherein conveying the feed mixture across the first side of the first heat exchanger comprises conveying the feed mixture at the target humidity across the first side of the first heat exchanger; and
wherein conveying the air mixture through the anode layer comprises regulating an air flow rate of the air mixture supplied to the anode layer based on the current.

11. The method of claim 1:
wherein conveying the air mixture through the anode layer comprises conveying the air mixture through the anode layer and a second anode layer of a second reversible fuel cell, in the set of reversible fuel cells, in the cell stack comprising:
the reversible fuel cell comprising the anode layer, an electrolyte layer arranged across the anode layer, and the cathode layer arranged across the electrolyte layer opposite the anode layer;
an interconnect arranged across the cathode layer opposite the electrolyte layer; and
a second reversible fuel cell comprising a second anode layer arranged across the interconnect opposite the cathode layer, a second electrolyte layer arranged across the second anode layer, and a second cathode layer arranged across the second electrolyte layer opposite the second anode layer; and
wherein conveying the feed mixture from the first heat exchanger outlet across the cathode layer comprises conveying the feed mixture from the first heat exchanger outlet across the cathode layer and the second cathode layer to generate a first portion of the first fuel mixture at the cathode layer and a second portion of the first fuel mixture at the second cathode layer via electrolysis of the feed mixture.

12. The method of claim 11, wherein conveying the air mixture through the anode layer and the second anode layer of the cell stack comprises conveying the air mixture through the anode layer and the second anode layer of the cell stack comprising the reversible fuel cell, the second reversible fuel cell, and the interconnect:
interposed between the first reversible fuel cell and the second reversible fuel cell; and
comprising a contact layer:
applied to surfaces of the interconnect;
comprising a first amount of Lanthanum, a second amount of Nickel, a third amount of Oxygen, a fourth amount of a second doping agent configured to stabilize a crystal structure of the material, a fifth amount of a first doping agent configured to limit thermal expansion of the interconnect; and
exhibiting:
a thermal expansion coefficient between 10.0×10-6K-1 and 15.0×10-6K-1 at temperatures between 25 degrees Celsius and 1100 degrees Celsius; and
an electrical conductivity greater than 200 Siemens-per-centimeter at temperatures within a temperature range of 700 degrees Celsius to 1300 degrees Celsius.

13. The method of claim 1:
wherein humidifying the gaseous mixture with the volume of water to generate the feed mixture at the humidification unit comprises humidifying the gaseous mixture with the volume of water to generate the feed mixture at the humidification unit of a feed supply module installed on a first region of a skid;
wherein conveying the feed mixture from the humidification unit across the first side of the first heat exchanger comprises conveying the feed mixture from the humidification unit across the first side of the first heat exchanger of an electrolysis module transiently installed within a second region of the skid and comprising:
a module housing comprising a layer of thermal insulation;
the cell stack transiently installed within the module housing; and
a set of heating elements installed within the module housing and comprising the first heat exchanger and a stack heater configured to regulate a temperature of the cell stack within a target stack temperature range;
wherein conveying the air mixture comprising oxygen through the anode layer of the reversible fuel cell in the cell stack comprises conveying the air mixture comprising oxygen through the anode layer of the reversible fuel cell in the cell stack of the electrolysis module and transiently installed within the module housing;
wherein conveying the first fuel mixture from the second heat exchanger outlet through the dryer unit comprises conveying the first fuel mixture from the second heat exchanger outlet through the dryer unit of a fuel processing module installed in a third region of the skid;
wherein conveying the second fuel mixture through the separator unit comprises conveying the second fuel mixture through the separator unit of the fuel processing module.

14. The method of claim 1:
wherein conveying the air mixture comprising oxygen through the anode layer of the reversible fuel cell comprises:
ingesting air from an air supply for extraction of the air mixture comprising a first concentration of oxygen;
conveying the air mixture across a first side of a second heat exchanger to heat the air mixture from a first air temperature at a third heat exchanger inlet to a second air temperature at a third heat exchanger outlet, the second air temperature exceeding the first air temperature;
conveying the air mixture from the third heat exchanger outlet across a first side of a third heat exchanger to heat the air mixture from the second air temperature at the third heat exchanger inlet to a third air temperature, within a target air temperature range, at a third heat exchanger outlet, the third air temperature exceeding the second air temperature; and
conveying the air mixture at the third air temperature through the anode layer of the reversible fuel cell in the cell stack, heated to a stack temperature within a target stack temperature range, to generate an oxygen mixture comprising a second concentration of oxygen exceeding the first concentration of oxygen via oxidation of the air mixture;
further comprising conveying the oxygen mixture from the anode layer across a second side of the third heat exchanger to cool the oxygen mixture from a first oxygen temperature at a fourth heat exchanger inlet to a second oxygen temperature at a fourth heat exchanger outlet, the second oxygen temperature less than the first oxygen temperature; and
wherein conveying the first fuel mixture from the second heat exchanger outlet through the dryer unit further comprises:
conveying the first fuel mixture from the second heat exchanger outlet across a second side of the second heat exchanger to cool the first fuel mixture from the second fuel temperature at a fourth heat exchanger inlet to a third fuel temperature at a fourth heat exchanger outlet, the third fuel temperature less than the second fuel temperature; and
conveying the first fuel mixture from the fourth heat exchanger outlet through the dryer unit.

15. A method comprising:
during a heating period:
conveying a feed mixture comprising water across a first side of a first heat exchanger to heat the feed mixture from a first feed temperature at a first heat exchanger inlet to a second feed temperature, within a target feed temperature range, at a first heat exchanger outlet, the second feed temperature exceeding the first feed temperature; and
conveying an air mixture comprising a first concentration of oxygen across a second side of a second heat exchanger to heat the air mixture from a first air temperature at a second heat exchanger inlet to a second air temperature, within a target air temperature range, at a second heat exchanger outlet, the second air temperature exceeding the first air temperature;
during an electrolysis period:
conveying the air mixture from the second heat exchanger outlet across an anode layer of a reversible fuel cell, in a cell stack, to generate an oxygen mixture via oxidation of the air mixture, the oxygen mixture comprising a second concentration of oxygen exceeding the first concentration; and
conveying the feed mixture from the first heat exchanger outlet across a cathode layer of the reversible fuel cell to generate a first fuel mixture at the cathode layer via electrolysis of the feed mixture, the first fuel mixture comprising hydrogen and a third concentration of secondary materials comprising water;
during a cooling period:
conveying the first fuel mixture across a third side of the first heat exchanger to cool the first fuel mixture from a first fuel temperature at a third heat exchanger inlet to a second fuel temperature at a third heat exchanger outlet, the second fuel temperature falling below the first fuel temperature; and
conveying the oxygen mixture across a fourth side of the second heat exchanger to cool the oxygen mixture from a first oxygen temperature at a fourth heat exchanger inlet to a second oxygen temperature at a fourth heat exchanger outlet, the second oxygen temperature falling below the first oxygen temperature;
conveying the first fuel mixture from the second heat exchanger outlet through a dryer unit configured to reduce a dew point of hydrogen in the first fuel mixture and promote separation of water from the first fuel mixture, to generate a second fuel mixture comprising hydrogen and a fourth concentration of secondary materials less than the third concentration; and
collecting the second fuel mixture at a dryer outlet of the dryer unit.

16. The method of claim 15:
wherein conveying the feed mixture comprising hydrogen across the first side of the first heat exchanger comprises conveying the feed mixture comprising water and carbon dioxide across the first side of the first heat exchanger;
wherein conveying the feed mixture from the first heat exchanger outlet across the cathode layer to generate the first fuel mixture comprising hydrogen and the third concentration of secondary materials comprises conveying the feed mixture from the first heat exchanger outlet across the cathode layer to generate the first fuel mixture comprising hydrogen, carbon monoxide, and the third concentration of secondary materials comprising water and carbon dioxide;
wherein conveying the first fuel mixture from the second heat exchanger outlet through the dryer unit configured to reduce the dew point of hydrogen in the first fuel mixture and promote separation of water from the first fuel mixture to generate the second fuel mixture comprising hydrogen and the fourth concentration of secondary materials comprises conveying the first fuel mixture from the second heat exchanger outlet through the dryer unit configured to reduce the dew point of hydrogen and carbon monoxide in the first fuel mixture and promote separation of water from the first fuel mixture to generate the second fuel mixture comprising hydrogen, carbon monoxide, and the fourth concentration of secondary materials comprising carbon dioxide; and
further comprising, conveying the second fuel mixture through a separator unit configured to extract carbon dioxide from the second fuel mixture to generate a third fuel mixture comprising hydrogen, carbon monoxide, and a fifth concentration of secondary materials less than the fourth concentration of secondary materials, the third fuel mixture comprising a concentration of hydrogen exceeding a first threshold concentration and a concentration of carbon monoxide exceeding a second threshold concentration.

17. The method of claim 15:
wherein conveying the feed mixture across the first side of the first heat exchanger further comprises:
heating water stored in a water tank to temperatures within a target water temperature range to promote transition of water, in the volume of water, from a liquid state to a vapor state;
conveying a volume of water in the vapor state from a tank outlet of the water tank to a feed inlet; and
conveying the volume of water across the first side of the first heat exchanger;
wherein conveying the first fuel mixture from the second heat exchanger outlet through the dryer unit configured to reduce the dew point of hydrogen in the first fuel mixture and promote separation of water from the first fuel mixture to generate the second fuel mixture comprises conveying the first fuel mixture from the second heat exchanger outlet through the dryer unit configured to reduce the dew point of hydrogen in the first fuel mixture and promote separation of water from the first fuel mixture to generate the second fuel mixture and a second volume of water in the liquid state;
wherein conveying the second fuel mixture from the dryer unit through the separator unit comprises conveying the second fuel mixture from a first dryer outlet of the dryer unit through the separator unit; and
further comprising, conveying the second volume of water, in the liquid state, from a second outlet of the separator unit into the water tank.

18. The system of claim 15:
wherein conveying the feed mixture across the first side of the first heat exchanger further comprises:
conveying a volume of water, in a liquid state, from a water tank through a compressor configured to pressurize the volume of water from a first pressure within a first pressure range at a compressor inlet to a second pressure within a second range at a compressor outlet, pressures within the second pressure range exceeding pressures within the first pressure range;
conveying the volume of water from the compressor outlet to a buffer tank;
conveying the volume of water from an outlet of the buffer tank to the first heat exchanger inlet via a water duct comprising a heating element configured to increase a temperature of the volume of water flowing through the water duct to transition the volume of water from the liquid state to a vapor state; and
conveying the volume of water, in the vapor state, across the first side of the first heat exchanger;
wherein conveying the first fuel mixture from the second heat exchanger outlet through the dryer unit configured to reduce the dew point of hydrogen in the first fuel mixture and promote separation of water from the first fuel mixture to generate the second fuel mixture comprises conveying the first fuel mixture from the second heat exchanger outlet through the dryer unit configured to reduce the dew point of hydrogen in the first fuel mixture and promote separation of water from the first fuel mixture to generate the second fuel mixture and a second volume of water in the liquid state;
wherein conveying the second fuel mixture from the dryer unit through the separator unit comprises conveying the second fuel mixture from a first dryer outlet of the dryer unit through the separator unit; and
further comprising, conveying the second volume of water, in the liquid state, from a second outlet of the separator unit into the water tank.

19. A method comprising:
during a live period for an electrolysis module installed on a skid:
selectively distributing power from a power supply to a cell stack to regulate a current applied across the cell stack within a target current range, the cell stack transiently installed within a housing of the electrolysis module and comprising a set of reversible fuel cells arranged in a vertical stack; and
selectively distributing power from the power supply to a set of heating elements installed within the housing to regulate a stack temperature of the reversible fuel cell stack within a target stack temperature range corresponding to the target stack efficiency;
during a first electrolysis cycle within the live period:
conveying an air mixture from an air supply across a set of anode layers of the cell stack at a first air flow rate corresponding to a first current applied to the reversible fuel cell during the first electrolysis cycle, the air mixture comprising oxygen; and
conveying a feed mixture, comprising water, from a feed supply across a set of cathode layers of the cell stack at a first feed flow rate to generate a fuel mixture comprising hydrogen via electrolysis, the first feed flow rate corresponding to the first current; and
during a second electrolysis cycle within the live period:
conveying the air mixture from the air supply across the set of anode layers at a second air flow rate corresponding to a second current applied to the reversible fuel cell during the first electrolysis cycle; and
conveying the feed mixture from the feed supply across the set of cathode layers at a second feed flow rate to generate the fuel mixture via electrolysis, the second feed flow rate corresponding to the second current.

20. The method of claim 19:
wherein conveying the feed mixture across the set of cathode layers at the first feed flow rate to generate the fuel mixture during the first electrolysis cycle comprises conveying the feed mixture across the set of cathode layers at the first feed flow rate to generate the fuel mixture comprising hydrogen and carbon monoxide, the feed mixture comprising carbon dioxide and a first amount of water corresponding to the first feed flow rate and a target humidity level defined for the feed mixture; and
wherein conveying the feed mixture across the set of cathode layers at the second feed flow rate to generate the fuel mixture during the second electrolysis cycle comprises conveying the feed mixture across the set of cathode layers at the second feed flow rate to generate the fuel mixture comprising hydrogen and carbon monoxide, the feed mixture comprising carbon dioxide and a second amount of water corresponding to the second feed flow rate and the target humidity level defined for the feed mixture.
